(19) United States
(12) Patent Application Publication
(10) Pub. No.: US 2026/0253268 A1
(43) Pub. Date: Aug. 27, 2026

(54) SYSTEM

(71) Applicant: SoftBank Group Corp., Tokyo (JP)

(72) Inventor: Hiroshi OTAKA, Tokyo (JP)

(73) Assignee: SoftBank Group Corp., Tokyo (JP)

(21) Appl. No.: 19/533,312

(22) Filed: Feb. 9, 2026

(30) Foreign Application Priority Data
Feb. 21, 2025 (JP) 2025-026986

(51) Int. Cl. G06T 11/00; G06F 3/01; G06F 3/04845; G10L 15/02; G10L 15/08; G10L 15/16; G10L 15/26; G10L 19/02; G10L 21/0208; G10L 25/63

(52) U.S. Cl. CPC G06T 11/00; G06F 3/013; G06F 3/04845; G10L 15/02; G10L 15/16; G10L 15/26; G10L 19/02; G10L 21/0208; G10L 25/63; G10L 2015/088

(57) ABSTRACT

The system according to the embodiment comprises a speech recognition unit, a generation unit, and a display unit. The speech recognition unit converts conversation content into text data. The generation unit analyzes the text data obtained by the speech recognition unit and generates an illustration. The display unit displays the illustration generated by the generation unit.

### CROSS-REFERENCE TO RELATED APPLICATION

The present application claims priority to and incorporates by reference the entire contents of Japanese Patent Application No. 2025-026986 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it is difficult to visually represent the conversation content during a meeting in real time, and there is room for improvement in terms of promoting participants' understanding and retention of information.

### SUMMARY OF THE INVENTION

The system according to the embodiment comprises a speech recognition unit, a generation unit, and a display unit. The speech recognition unit converts conversation content into text data. The generation unit analyzes the text data obtained by the speech recognition unit and generates an illustration. The display unit displays the illustration generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

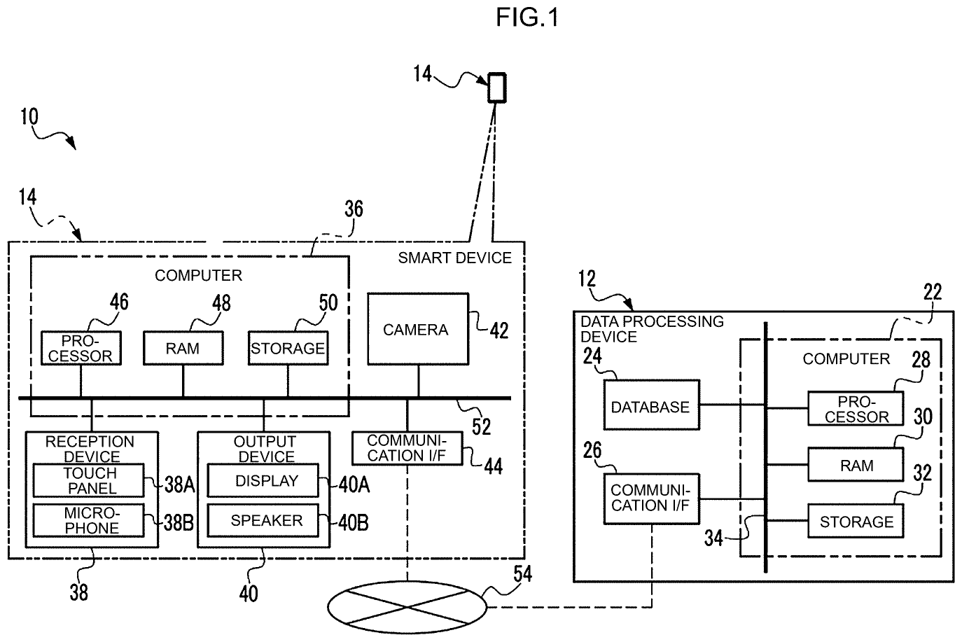

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

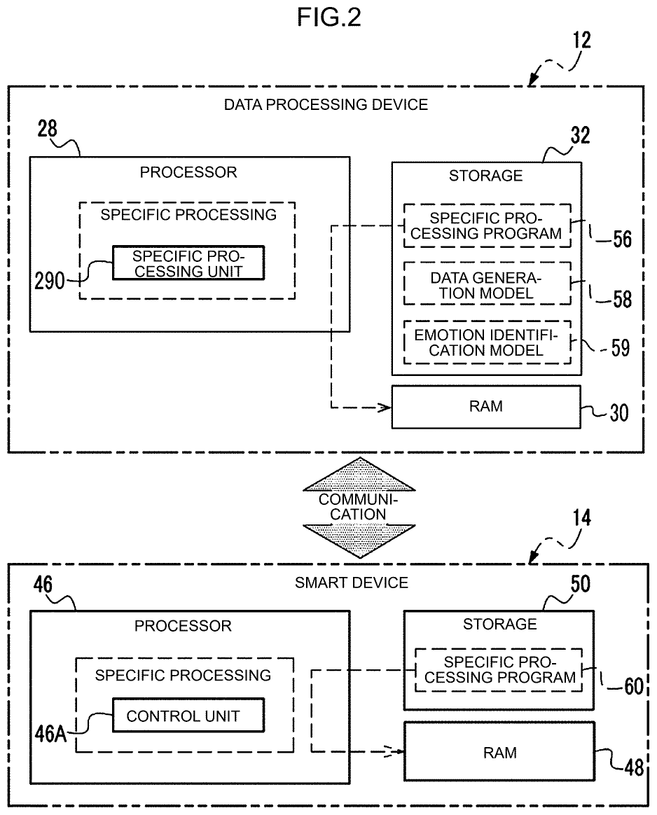

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The meeting support system according to the embodiment of the present invention is a system that captures the conversation content in meetings or conferences in real time and uses an illustration generation AI to visualize the image of the conversation as an illustration. This meeting support system stimulates the imagination of participants and enables concepts and ideas to be conveyed more clearly. Specifically, the system consists of the following steps. First, the conversation content of the meeting is captured in real time. At this time, speech recognition technology is used to convert the conversation content into text data. For example, when content such as “discussing a specific concept or idea” is spoken during the meeting, that content is acquired as text data. Next, the acquired text data is input to the illustration generation AI. The illustration generation AI analyzes the input text data and generates an illustration based on its content. For example, based on text data such as “specific concept or idea,” the corresponding image is generated as an illustration. The generated illustration is displayed to the meeting participants in real time. As a result, participants can visually understand content that cannot be fully expressed by words alone. For example, by displaying the image of a specific concept or idea as an illustration, participants can concretely imagine its content. Through this system, meeting participants can visually capture information via illustrations and convey concepts and ideas more clearly. Furthermore, the illustrations captivate the meeting participants and promote retention and understanding of information. For example, by displaying the image of a specific concept or idea as an illustration, participants can more easily concretely imagine its content, leading to a deeper understanding of the meeting content. Thus, the meeting support system stimulates the imagination of participants and enables concepts and ideas to be conveyed more clearly. Specifically, the meeting support system comprises three main modules: a speech recognition unit, a generation unit, and a display unit. The speech recognition unit acquires the speech of meeting participants via a high-precision microphone array or over a network, extracts acoustic features (e.g., Mel-frequency cepstral coefficients, spectrograms, etc.), and inputs them to a speech recognition model using convolutional neural networks or recurrent neural networks. Input data may include, for example, a 1-second audio waveform sampled at 16 kHz (a one-dimensional array of 16,000 samples) or a spectrogram image (a two-dimensional tensor of 128×128 pixels). The speech recognition model outputs the spoken content as a string sequence. Examples of output include text such as “Let's discuss the design of the new product” or “Let's decide the schedule for the next meeting.” The generation unit first inputs the text data obtained from the speech recognition unit to a natural language processing module (e.g., a transformer-based large language model), performs context analysis and keyword extraction (e.g., TF-IDF, attention weighting), and uses the extracted keywords and context information as prompts for an image generation model (e.g., diffusion model, GAN, VQ-VAE, etc.). Examples of input to the image generation model include natural language prompts such as “depict the image of the new product on a blue background” or “illustrate the scene of multiple people discussing in a meeting room.” The image generation model outputs RGB images (for example, a three-dimensional tensor of 512×512 pixels) based on these prompts. Examples of output include “sketch-style illustration of the new product” or “bird's-eye view of the meeting room.” The display unit displays the generated illustration images in real time on the interface of a web browser or dedicated application. The display unit also automatically performs post-processing such as resolution adjustment, display position, scaling, and color correction, and optimizes the delivery for the screen size and resolution of participants' devices (PCs, tablets, smartphones, etc.). Furthermore, the timing of illustration display is dynamically controlled according to the progress of the meeting and the importance of the spoken content. For example, related illustrations can be instantly displayed at the moment an important topic is presented, or multiple illustrations can be displayed in parallel to encourage comparative review. These series of processes are technically characterized by the computer autonomously performing feature extraction in high-dimensional space and optimization of generation model weight parameters, unlike conventional manual work (e.g., a minute taker drawing illustrations by hand). As a technical effect, this system automates the visualization of meeting content, thereby reducing recognition discrepancies among participants, improving the efficiency of discussions, and speeding up decision-making. In addition, flexible information presentation that was difficult with conventional technology becomes possible, such as rapid illustration generation (within a few seconds), generation of diverse styles, and customized display for each participant. Specific application fields include corporate planning meetings, R&D meetings, group work in educational settings, and multilingual visualization in international conferences. Furthermore, by combining multiple generation models, extended applications such as animation and 3D model generation, and dynamic changes in illustration style based on emotion estimation are also possible. Through these configurations and processing procedures, the present invention not only automates human tasks but also contributes to the advancement of computer technology itself and the creation of new information presentation methods.

The meeting support system according to the embodiment comprises a speech recognition unit, a generation unit, and a display unit. The speech recognition unit captures the conversation content of the meeting in real time and converts it into text data. The conversation content of the meeting may include, for example, business conversations, daily conversations, technical discussions, and the like, but is not limited thereto. The speech recognition unit, for example, uses speech recognition technology to convert the conversation content into text data. The text data may include, for example, plain text, XML format, JSON format, and the like, but is not limited thereto. The generation unit uses a generation AI to analyze the text data obtained by the speech recognition unit and generates an illustration based on its content. The generation unit may analyze the text data using a text generation AI (e.g., LLM) and generate an illustration. The generation unit may also use a multimodal generation AI to analyze the text data and generate an illustration. The generation unit may use keyword extraction technology to pick up particularly important information from the text data and generate an illustration based on that information. The display unit displays the illustration generated by the generation unit in real time. The display unit, for example, displays the generated illustration to the meeting participants in real time. The display unit may display the generated illustration within a few seconds. Thus, the meeting support system according to the embodiment can provide visual information to meeting participants in real time. Some or all of the above-described processing in the generation unit may be performed using a generation AI or may be performed without using a generation AI. For example, the generation unit may input the text data to the generation AI and have the generation AI execute the illustration generation. As a result, the meeting support system can promote participants' understanding. Specifically, in the meeting support system, the speech recognition unit acquires the speech of meeting participants via a high-sensitivity microphone array or over a network, extracts acoustic features (e.g., Mel-frequency cepstral coefficients, spectrograms, etc.), and inputs them to a speech recognition model using convolutional neural networks or recurrent neural networks. Input data may include, for example, a 1-second audio waveform sampled at 16 kHz (a one-dimensional array of 16,000 samples) or a spectrogram image (a two-dimensional tensor of 128×128 pixels). The speech recognition model outputs the spoken content as a string sequence. Examples of output include text such as “Let's discuss the design of the new product” or “Let's decide the schedule for the next meeting.” The generation unit inputs the text data obtained from the speech recognition unit to a natural language processing module (e.g., a transformer-based large language model), performs context analysis and keyword extraction (e.g., TF-IDF, attention weighting), and uses the extracted keywords and context information as prompts for an image generation model (e.g., diffusion model, GAN, VQ-VAE, etc.). Examples of input to the image generation model include natural language prompts such as “depict the image of the new product on a blue background” or “illustrate the scene of multiple people discussing in a meeting room.” The image generation model outputs RGB images (for example, a three-dimensional tensor of 512×512 pixels) based on these prompts. Examples of output include “sketch-style illustration of the new product” or “bird's-eye view of the meeting room.” The display unit displays the generated illustration images in real time on the interface of a web browser or dedicated application. The display unit also automatically performs post-processing such as resolution adjustment, display position, scaling, and color correction, and optimizes the delivery for the screen size and resolution of participants' devices (PCs, tablets, smartphones, etc.). Furthermore, the timing of illustration display is dynamically controlled according to the progress of the meeting and the importance of the spoken content. For example, related illustrations can be instantly displayed at the moment an important topic is presented, or multiple illustrations can be displayed in parallel to encourage comparative review. These series of processes are technically characterized by the computer autonomously performing feature extraction in high-dimensional space and optimization of generation model weight parameters, unlike conventional manual work (e.g., a minute taker drawing illustrations by hand). As a technical effect, this system automates the visualization of meeting content, thereby reducing recognition discrepancies among participants, improving the efficiency of discussions, and speeding up decision-making. In addition, flexible information presentation that was difficult with conventional technology becomes possible, such as rapid illustration generation (within a few seconds), generation of diverse styles, and customized display for each participant. Specific application fields include corporate planning meetings, R&D meetings, group work in educational settings, and multilingual visualization in international conferences. Furthermore, by combining multiple generation models, extended applications such as animation and 3D model generation, and dynamic changes in illustration style based on emotion estimation are also possible. Through these configurations and processing procedures, the present invention not only automates human tasks but also contributes to the advancement of computer technology itself and the creation of new information presentation methods.

The speech recognition unit can capture the conversation content of a meeting in real time and convert it into text data. For example, the speech recognition unit captures the conversation content of a meeting in real time and converts it into text data. The specific time range for real time may include, for example, within a few seconds or on the order of milliseconds, but is not limited thereto. By converting the conversation content of a meeting into text data in real time, rapid information processing becomes possible. Some or all of the above-described processing in the speech recognition unit may be performed using AI or may be performed without using AI. For example, the speech recognition unit may input the conversation content of a meeting to AI and have the AI execute the conversion to text data. Specifically, the speech recognition unit acquires the speech of meeting participants via a high-sensitivity microphone array or over a network, extracts acoustic features (e.g., Mel-frequency cepstral coefficients, spectrograms, etc.), and inputs them to a speech recognition model using convolutional neural networks or recurrent neural networks. Input data may include, for example, a 1-second audio waveform sampled at 16 kHz (a one-dimensional array of 16,000 samples) or a spectrogram image (a two-dimensional tensor of 128×128 pixels). The speech recognition model outputs the spoken content as a string sequence. Examples of output include text such as “Let's discuss the design of the new product” or “Let's decide the schedule for the next meeting.” To ensure real-time performance, the speech recognition unit utilizes streaming speech recognition algorithms or parallelization of batch processing to achieve text conversion with a delay of only a few seconds. Furthermore, the weight parameters of the speech recognition model can be pre-trained or fine-tuned according to the domain of the meeting or the speaking tendencies of the participants, thereby improving recognition accuracy and reducing misrecognition. As a technical effect, the speech recognition unit achieves overwhelming processing speed and high recognition accuracy compared to conventional manual minute-taking or manual transcription, enabling immediate sharing of information without hindering the progress of the meeting. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The generation unit can analyze text data and generate an illustration based on its content. For example, the generation unit analyzes text data and generates an illustration based on its content. Specific methods and criteria for analysis may include keyword extraction, context analysis, and the like, but are not limited thereto. The generation unit may use keyword extraction technology to pick up particularly important information from the text data and generate an illustration based on that information. The generation unit may also use context analysis technology to understand the context of the text data and generate an illustration based on that context. By analyzing text data and generating an illustration, visual information provision becomes possible. Some or all of the above-described processing in the generation unit may be performed using a generation AI or may be performed without using a generation AI. For example, the generation unit may input text data to the generation AI and have the generation AI execute the illustration generation. Specifically, the generation unit inputs the text data obtained from the speech recognition unit to a natural language processing module (e.g., a transformer-based large language model), performs context analysis and keyword extraction (e.g., TF-IDF, attention weighting). Examples of input data include natural language text such as “Let's discuss the design of the new product” or “Let's decide the schedule for the next meeting.” The natural language processing module extracts important keywords (e.g., “new product,” “design,” “meeting schedule”) and context information (e.g., purpose or background of the discussion) from these texts. The extracted information is used as prompts for an image generation model (e.g., diffusion model, GAN, VQ-VAE, etc.). Examples of input to the image generation model include natural language prompts such as “depict the image of the new product on a blue background” or “illustrate the scene of multiple people discussing in a meeting room.” The image generation model outputs RGB images (for example, a three-dimensional tensor of 512×512 pixels) based on these prompts. Examples of output include “sketch-style illustration of the new product” or “bird's-eye view of the meeting room.” The generation unit can optimize the quality and style of the generated illustrations by pre-training or fine-tuning the weight parameters of the image generation model according to the domain of the meeting or the preferences of the participants. Furthermore, the generation unit can combine multiple image generation models to simultaneously generate illustrations of different styles and resolutions and select the optimal illustration based on participant feedback. As a technical effect, the generation unit achieves overwhelming generation speed and diverse style expression compared to conventional manual illustration creation or manual editing, enabling immediate visualization of information without hindering the progress of the meeting. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can display the generated illustration in real time. For example, the display unit displays the generated illustration in real time. The specific time range for real time may include, for example, within a few seconds or on the order of milliseconds, but is not limited thereto. By displaying the generated illustration in real time, visual information can be provided instantly to meeting participants. Some or all of the above-described processing in the display unit may be performed using AI or may be performed without using AI. For example, the display unit may input the generated illustration to AI and have the AI execute the real-time display. Specifically, the display unit displays the illustration image output from the generation unit (for example, a 512×512 pixel RGB image tensor) in real time on the interface of a web browser or dedicated application. The display unit also automatically performs post-processing such as resolution adjustment, display position, scaling, and color correction, and optimizes the delivery for the screen size and resolution of participants' devices (PCs, tablets, smartphones, etc.). For example, if a participant is using a smartphone, the image is automatically resized; if using a tablet, it is displayed in high resolution, and so on, selecting the optimal display method for each device. Furthermore, the timing of illustration display is dynamically controlled according to the progress of the meeting and the importance of the spoken content. For example, related illustrations can be instantly displayed at the moment an important topic is presented, or multiple illustrations can be displayed in parallel to encourage comparative review. To ensure real-time performance, the display unit utilizes image data streaming, cache control, and delay compensation algorithms to display illustrations with a delay of only a few seconds. As a technical effect, the display unit achieves overwhelming display speed and flexible layout control compared to conventional manual image display or static material distribution, enabling immediate sharing of information without hindering the progress of the meeting. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can generate an image of a specific concept or idea as an illustration. For example, the generation unit generates an image of a specific concept or idea as an illustration. Specific types and ranges of concepts or ideas may include, for example, business concepts, technical ideas, and the like, but are not limited thereto. By generating an image of a specific concept or idea as an illustration, participants' understanding can be deepened. Some or all of the above-described processing in the generation unit may be performed using a generation AI or may be performed without using a generation AI. For example, the generation unit may input text data of a specific concept or idea to the generation AI and have the generation AI execute the illustration generation. Specifically, the generation unit inputs descriptions related to specific concepts or ideas from the text data obtained from the speech recognition unit to a natural language processing module (e.g., a transformer-based large language model) and performs keyword extraction and context analysis. Examples of input data include text such as “new product design,” “sustainable energy strategy,” “next-generation communication technology,” and the like. The natural language processing module extracts main keywords and related attribute information (e.g., “design,” “energy,” “communication”) from these texts and uses them as prompts for an image generation model (e.g., diffusion model, GAN, VQ-VAE, etc.). Examples of input to the image generation model include prompts such as “depict the new product design in a futuristic style” or “illustration symbolizing a sustainable energy strategy.” The image generation model outputs RGB images (for example, a three-dimensional tensor of 512×512 pixels) based on these prompts. Examples of output include “futuristic illustration of a new product” or “image of an energy strategy combining solar panels and wind power generation.” The generation unit can optimize the quality and style of the generated illustrations by pre-training or fine-tuning the weight parameters of the image generation model according to the domain of the meeting or the preferences of the participants. Furthermore, by combining multiple image generation models, the generation unit can simultaneously generate illustrations of different styles and resolutions and select the optimal illustration based on participant feedback. As a technical effect, the generation unit achieves overwhelming generation speed and diverse style expression compared to conventional manual illustration creation or manual editing, enabling immediate visualization of information without hindering the progress of the meeting. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can enable information to be visually captured through illustrations. For example, the display unit enables information to be visually captured through illustrations. Specific methods and criteria for visually capturing information may include, for example, visual emphasis, use of colors, and the like, but are not limited thereto. By visually capturing information through illustrations, participants' understanding can be promoted. Some or all of the above-described processing in the display unit may be performed using AI or may be performed without using AI. For example, the display unit may input the generated illustration to AI and have the AI execute the display for visual capture. Specifically, the display unit displays the illustration image output from the generation unit (for example, a 512×512 pixel RGB image tensor) in real time on the interface of a web browser or dedicated application. The display unit also automatically performs post-processing such as resolution adjustment, display position, scaling, color correction, and visual emphasis (e.g., highlighting important parts, emphasizing color contrast), and optimizes the delivery for the screen size and resolution of participants' devices (PCs, tablets, smartphones, etc.). For example, the part of the illustration related to important keywords can be highlighted in bright colors, or the display layout of the illustration can be dynamically changed according to the progress of the meeting. Furthermore, the timing and method of illustration display are dynamically controlled based on the progress of the meeting, participants' gaze data, emotion estimation results, and the like. For example, if participants' gaze is concentrated on a particular illustration, that illustration can be enlarged, or if gaze is dispersed, multiple illustrations can be displayed simultaneously. To ensure real-time performance, the display unit utilizes image data streaming, cache control, and delay compensation algorithms to display illustrations with a delay of only a few seconds. As a technical effect, the display unit achieves overwhelming display speed, flexible layout control, and improved information transmission efficiency through visual emphasis compared to conventional manual image display or static material distribution, enabling immediate sharing of information without hindering the progress of the meeting. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The speech recognition unit can estimate the emotions of meeting participants and adjust the accuracy of speech recognition based on the estimated emotions. For example, the speech recognition unit estimates the emotions of meeting participants and adjusts the accuracy of speech recognition based on the estimated emotions. Methods and criteria for emotion estimation may include, for example, facial expression recognition, voice tone analysis, and the like, but are not limited thereto. For example, if a meeting participant is nervous, the accuracy of speech recognition is increased to accurately capture the spoken content. If a meeting participant is relaxed, the accuracy of speech recognition is maintained at a normal level to capture natural conversation. If a meeting participant is excited, the accuracy of speech recognition is adjusted to preferentially capture important statements. By adjusting the accuracy of speech recognition according to the emotions of meeting participants, the spoken content can be accurately captured. Emotion estimation is realized using, for example, an emotion engine or a generation AI with emotion estimation functionality. The generation AI may be, for example, a text generation AI (e.g., LLM) or a multimodal generation AI, but is not limited thereto. Some or all of the above-described processing in the speech recognition unit may be performed using AI or may be performed without using AI. For example, the speech recognition unit may input emotion data of meeting participants to the generation AI and have the generation AI execute the adjustment of speech recognition accuracy. Specifically, the speech recognition unit acquires input data such as speech audio, facial images, and biometric data (e.g., audio waveform, facial image, heart rate, etc.) of meeting participants. Examples of input include a 1-second audio waveform (16,000 samples), a facial image (128×128 pixel RGB image), and voice tone features during speech (pitch, energy, etc.). An emotion estimation model (e.g., multimodal neural network) outputs emotion labels (e.g., “nervous,” “relaxed,” “excited”) or emotion scores (continuous values from 0.0 to 1.0) from these inputs. Examples of output include “nervousness level 0.8,” “relaxation level 0.2,” and so on. The speech recognition unit dynamically adjusts parameters such as the threshold of the speech recognition model, decoder beam width, and noise filter strength according to the estimated emotion values. For example, if the nervousness level is high, the recognition threshold is lowered to prevent misrecognition; if the excitement level is high, the detection sensitivity for important statements is increased, and so on. As a result, speech recognition processing optimized for the emotional state of meeting participants is realized, enabling accurate conversion of spoken content into text. As a technical effect, the speech recognition unit achieves flexible accuracy control according to emotional state compared to conventional speech recognition with uniform parameters, thereby improving the progress and quality of discussions in meetings. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The speech recognition unit can preferentially convert important statements into text data according to the progress of the meeting. For example, the speech recognition unit preferentially converts important statements into text data according to the progress of the meeting. Specific criteria and methods for important statements may include, for example, keyword frequency, context of statements, and the like, but are not limited thereto. For example, important statements at the beginning of the meeting are preferentially converted into text data. Key points of discussion in the middle of the meeting can be preferentially converted into text data. Conclusions or decisions at the end of the meeting can also be preferentially converted into text data. By preferentially converting important statements into text data according to the progress of the meeting, important information can be quickly grasped. Some or all of the above-described processing in the speech recognition unit may be performed using a generation AI or may be performed without using a generation AI. For example, the speech recognition unit may input the progress of the meeting to the generation AI and have the generation AI execute the preferential conversion of important statements. Specifically, the speech recognition unit receives meeting progress data (e.g., topic start/end timestamps, speaker list, meeting progress logs, etc.) and real-time speech audio data as input. Examples of input include progress labels such as “meeting start: explanation of new product concept,” “meeting middle: discussion of technical issues,” “meeting end: confirmation of decisions,” and corresponding audio waveform data. The speech recognition unit uses a natural language processing module (e.g., transformer-based large language model) to calculate keyword frequency and contextual importance scores from the spoken content. For example, statements containing frequently occurring keywords such as “decision,” “approval,” “issue,” “proposal,” or statements judged to be important in the context of meeting progress are preferentially converted into text. Examples of output include “The concept of the new product is decided as proposal A” or “The next meeting will be held next Monday.” The speech recognition unit dynamically controls the priority of text conversion and the timing of real-time display based on importance scores. As a result, information extraction and immediate sharing optimized for the progress of the meeting are realized, enabling participants to quickly grasp important information. As a technical effect, the speech recognition unit achieves flexible information presentation according to the flow of the meeting and key points of discussion compared to conventional uniform text conversion, thereby promoting efficient minute-taking and decision-making. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The speech recognition unit can emphasize specific keywords and convert them into text data based on the theme or content of the meeting. For example, the speech recognition unit emphasizes specific keywords and converts them into text data based on the theme or content of the meeting. Methods and criteria for emphasizing specific keywords may include, for example, changing the font, changing the color, and the like, but are not limited thereto. For example, if the theme of the meeting is “marketing strategy,” keywords such as “strategy,” “market,” and “customer” are emphasized and converted into text data. If the content of the meeting is “new product development,” keywords such as “development,” “product,” and “technology” are emphasized and converted into text data. If the theme of the meeting is “budget planning,” keywords such as “budget,” “planning,” and “funding” are emphasized and converted into text data. By emphasizing specific keywords based on the theme or content of the meeting, important information can be highlighted and conveyed. Some or all of the above-described processing in the speech recognition unit may be performed using a generation AI or may be performed without using a generation AI. For example, the speech recognition unit may input the theme or content of the meeting to the generation AI and have the generation AI execute the emphasis of specific keywords. Specifically, the speech recognition unit receives meeting theme data (e.g., “marketing strategy,” “new product development,” “budget planning,” etc.) and real-time speech audio data as input. Examples of input include “meeting theme: marketing strategy,” “statement content: discussion about developing a new market,” and so on. The speech recognition unit uses a natural language processing module (e.g., transformer-based large language model) to extract keywords related to the theme (e.g., “strategy,” “market,” “customer”) from the spoken content and adds emphasis attributes (e.g., bold, colored, underlined, etc.) when converting to text data. Examples of output include “Discussion about developing a new market (market: emphasized)” or “Review of budget planning (budget: emphasized).” The speech recognition unit also utilizes emphasized keywords for illustration generation prompts and extraction of key points in minutes, enabling meeting participants to intuitively grasp important information. As a technical effect, the speech recognition unit achieves information emphasis according to the theme or content of the meeting compared to conventional uniform text conversion, thereby promoting efficient minute-taking and decision-making. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The speech recognition unit can estimate the emotions of meeting participants and adjust the timing of speech recognition based on the estimated emotions. For example, the speech recognition unit estimates the emotions of meeting participants and adjusts the timing of speech recognition based on the estimated emotions. Methods and criteria for emotion estimation may include, for example, facial expression recognition, voice tone analysis, and the like, but are not limited thereto. For example, if a meeting participant is nervous, the timing of speech recognition is adjusted considering the intervals between statements. If a meeting participant is relaxed, the timing of speech recognition is adjusted to match the natural flow of conversation. If a meeting participant is excited, speech recognition is performed preferentially at the timing of important statements. By adjusting the timing of speech recognition according to the emotions of meeting participants, the natural flow of conversation can be maintained. Emotion estimation is realized using, for example, an emotion engine or a generation AI with emotion estimation functionality. The generation AI may be, for example, a text generation AI (e.g., LLM) or a multimodal generation AI, but is not limited thereto. Some or all of the above-described processing in the speech recognition unit may be performed using AI or may be performed without using AI. For example, the speech recognition unit may input emotion data of meeting participants to the generation AI and have the generation AI execute the timing adjustment of speech recognition. Specifically, the speech recognition unit acquires input data such as speech audio, facial images, and biometric data (e.g., audio waveform, facial image, heart rate, etc.) of meeting participants. Examples of input include a 1-second audio waveform (16,000 samples), a facial image (128×128 pixel RGB image), and voice tone features during speech (pitch, energy, etc.). An emotion estimation model (e.g., multimodal neural network) outputs emotion labels (e.g., “nervous,” “relaxed,” “excited”) or emotion scores (continuous values from 0.0 to 1.0) from these inputs. Examples of output include “nervousness level 0.8,” “relaxation level 0.2,” and so on. The speech recognition unit dynamically adjusts the start/end timing of speech recognition and the detection threshold for speech segments according to the estimated emotion values. For example, if the nervousness level is high, the silent interval between statements is set longer; if the excitement level is high, speech segments are divided into shorter intervals to preferentially recognize important statements. As a result, speech recognition timing optimized for the emotional state of meeting participants is realized, preventing the omission of important information while maintaining the natural flow of conversation. As a technical effect, the speech recognition unit achieves flexible timing adjustment according to emotional state compared to conventional uniform timing control, thereby improving the progress and quality of discussions in meetings. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The speech recognition unit can enhance noise canceling functionality based on the location of the meeting or environmental sounds. For example, the speech recognition unit enhances noise canceling functionality based on the location of the meeting or environmental sounds. Specific methods and criteria for noise canceling may include, for example, removal of specific frequency bands, filtering of environmental sounds, and the like, but are not limited thereto. For example, the environmental sounds of the meeting location are analyzed in real time to enhance noise canceling functionality. External noise from outside the meeting room can be detected and noise canceling functionality can be enhanced. Noise from participants during the meeting can also be detected and noise canceling functionality can be enhanced. By enhancing noise canceling functionality based on the location of the meeting or environmental sounds, the spoken content can be accurately captured. Some or all of the above-described processing in the speech recognition unit may be performed using a generation AI or may be performed without using a generation AI. For example, the speech recognition unit may input location or environmental sound data of the meeting to the generation AI and have the generation AI execute the enhancement of noise canceling functionality. Specifically, the speech recognition unit receives environmental sound data of the meeting room (e.g., multi-channel audio waveforms obtained from a microphone array, noise level information from environmental sensors, etc.) as input. Examples of input include multi-channel audio waveforms for 5 seconds (16,000 samples per channel), real-time noise level (in dB), frequency spectrum data (256 bands from 0 to 8 kHz), and so on. A noise canceling model (e.g., spectral subtraction method, self-supervised neural network, Wiener filter, etc.) estimates noise components from these inputs and outputs a clean audio waveform with noise removed from the speech signal. Examples of output include “audio waveform after noise removal,” “residual noise level 0.05,” and so on. The speech recognition unit inputs the audio waveform after noise removal to the speech recognition model and converts the spoken content into text with high accuracy. Furthermore, metadata such as the location, time, and number of participants in the meeting can be used to dynamically optimize the parameters of the noise canceling model. As a technical effect, the speech recognition unit achieves flexible noise suppression according to environmental changes compared to conventional fixed-parameter noise removal, thereby improving the progress and quality of discussions in meetings. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The speech recognition unit can analyze the frequency of utterances of meeting participants and apply different speech recognition algorithms for each speaker. For example, the speech recognition unit analyzes the frequency of utterances of meeting participants and applies different speech recognition algorithms for each speaker. Methods and criteria for analyzing utterance frequency may include, for example, counting the number of utterances, measuring utterance time, and the like, but are not limited thereto. For example, a high-accuracy speech recognition algorithm is applied to participants with high utterance frequency. A standard speech recognition algorithm can be applied to participants with low utterance frequency. The speech recognition algorithm can also be dynamically adjusted according to changes in utterance frequency. By adjusting the speech recognition algorithm according to the frequency of utterances of meeting participants, the spoken content can be accurately captured. Some or all of the above-described processing in the speech recognition unit may be performed using a generation AI or may be performed without using a generation AI. For example, the speech recognition unit may input utterance frequency data of meeting participants to the generation AI and have the generation AI execute the application of speech recognition algorithms. Specifically, the speech recognition unit receives utterance history data for each meeting participant (e.g., number of utterances, total utterance time, interval between utterances, etc.) as input. Examples of input include “Participant A: 15 utterances, total utterance time 10 minutes,” “Participant B: 3 utterances, total utterance time 2 minutes,” and so on. An utterance frequency analysis module (e.g., time series analysis model, clustering algorithm) analyzes these data to determine the utterance tendencies of each participant and outputs utterance frequency scores or cluster labels. Examples of output include “Participant A: high frequency,” “Participant B: low frequency,” and so on. The speech recognition unit dynamically selects and adjusts the type and parameters of the speech recognition model (e.g., beam width, dictionary size, noise filter strength, etc.) according to the utterance frequency score. For example, a high-accuracy model is applied to high-frequency speakers, and a standard model is applied to low-frequency speakers, thereby optimizing overall recognition accuracy and computational efficiency. Furthermore, the model can be retrained or parameters automatically optimized according to changes in utterance frequency. As a technical effect, the speech recognition unit achieves flexible recognition control according to the utterance characteristics of each participant compared to conventional uniform model application, thereby improving the progress and quality of discussions in meetings. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The generation unit can estimate the emotions of meeting participants and adjust the style of the illustration based on the estimated emotions. For example, the generation unit estimates the emotions of meeting participants and adjusts the style of the illustration based on the estimated emotions. Methods and criteria for emotion estimation may include, for example, facial expression recognition, voice tone analysis, and the like, but are not limited thereto. For example, if a meeting participant is relaxed, a soft-touch illustration is generated. If a meeting participant is excited, an illustration with vivid colors is generated. If a meeting participant is nervous, an illustration with calm colors is generated. By adjusting the style of the illustration according to the emotions of meeting participants, participants' understanding can be deepened. Emotion estimation is realized using, for example, an emotion engine or a generation AI with emotion estimation functionality. The generation AI may be, for example, a text generation AI (e.g., LLM) or a multimodal generation AI, but is not limited thereto. Some or all of the above-described processing in the generation unit may be performed using AI or may be performed without using AI. For example, the generation unit may input emotion data of meeting participants to the generation AI and have the generation AI execute the style adjustment of the illustration. Specifically, the generation unit acquires input data such as speech audio, facial images, and biometric data (e.g., audio waveform, facial image, heart rate, etc.) of meeting participants. Examples of input include a 1-second audio waveform (16,000 samples), a facial image (128×128 pixel RGB image), and voice tone features during speech (pitch, energy, etc.). An emotion estimation model (e.g., multimodal neural network) outputs emotion labels (e.g., “nervous,” “relaxed,” “excited”) or emotion scores (continuous values from 0.0 to 1.0) from these inputs. Examples of output include “nervousness level 0.8,” “relaxation level 0.2,” and so on. The generation unit dynamically adjusts prompts and style parameters (e.g., color tone, line thickness, texture, etc.) for the image generation model (e.g., diffusion model, GAN, VQ-VAE, etc.) according to the estimated emotion values. For example, if the relaxation level is high, soft colors and curvilinear touches are specified; if the excitement level is high, vivid colors and dynamic compositions are specified; if the nervousness level is high, calm colors and simple layouts are specified. The image generation model outputs RGB images (for example, a three-dimensional tensor of 512×512 pixels) based on these prompts. Examples of output include “soft-touch illustration,” “vividly colored illustration,” “calmly colored illustration,” and so on. As a technical effect, the generation unit achieves flexible illustration expression according to the emotional state of participants compared to conventional uniform style generation, thereby improving the progress and quality of discussions in meetings. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can generate a plurality of illustrations based on the content of the text data and select the optimal one. For example, the generation unit generates a plurality of illustrations based on the content of the text data and selects the optimal one. Criteria and methods for selecting the optimal illustration may include, for example, participant feedback, algorithmic evaluation, and the like, but are not limited thereto. For example, a plurality of illustrations of different styles can be generated based on the content of the text data. The illustration most suitable for the theme of the meeting can be selected from among the generated illustrations. The optimal illustration can also be selected based on participant reactions. By generating a plurality of illustrations based on the content of the text data and selecting the optimal one, participants' understanding can be deepened. Some or all of the above-described processing in the generation unit may be performed using a generation AI or may be performed without using a generation AI. For example, the generation unit may input text data to the generation AI and have the generation AI execute the generation of multiple illustrations and selection of the optimal one. Specifically, the generation unit inputs the text data obtained from the speech recognition unit to a natural language processing module (e.g., transformer-based large language model) and performs context analysis and keyword extraction. Examples of input include natural language text such as “Let's discuss the design of the new product” or “Let's decide the schedule for the next meeting.” The generation unit generates multiple prompts specifying different styles, compositions, and color parameters for the image generation model (e.g., diffusion model, GAN, VQ-VAE, etc.) based on the extracted information. The image generation model simultaneously outputs multiple RGB images (for example, a three-dimensional tensor of 512×512 pixels) based on these prompts. Examples of output include “sketch-style illustration,” “watercolor-style illustration,” “pop art-style illustration,” and so on. The generation unit selects the optimal illustration using participant feedback (e.g., real-time voting, number of clicks, gaze concentration, etc.) or algorithmic automatic evaluation (e.g., image clarity, theme suitability score, etc.). The selected illustration is presented to meeting participants via the display unit. As a technical effect, the generation unit achieves optimal information presentation from diverse expressions compared to conventional single illustration generation, thereby improving participants' understanding and satisfaction. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can analyze the context of the text data and generate an illustration including related background information. For example, the generation unit analyzes the context of the text data and generates an illustration including related background information. Specific methods and criteria for context analysis may include, for example, understanding the preceding and following context, extracting related information, and the like, but are not limited thereto. For example, the generation unit analyzes the context of the text data and generates an illustration including related background information. The generation unit can also generate an illustration based on background information related to the theme of the meeting. The generation unit can also generate an illustration based on background information related to the content of the meeting. By analyzing the context of the text data and generating an illustration including related background information, participants' understanding can be deepened. Some or all of the above-described processing in the generation unit may be performed using a generation AI or may be performed without using a generation AI. For example, the generation unit may input text data to the generation AI and have the generation AI execute context analysis and generation of illustrations including background information. Specifically, the generation unit inputs the text data obtained from the speech recognition unit to a natural language processing module (e.g., transformer-based large language model) and performs context analysis (e.g., understanding relationships, detecting topic transitions, extracting related information, etc.). Examples of input include multi-sentence text such as “Let's discuss the design of the new product. Considering market needs . . . ” or “Let's decide the schedule for the next meeting. Checking participants' availability . . . ” The natural language processing module extracts main keywords and related background information (e.g., “market needs,” “participants' availability”) from these texts and uses them as prompts for an image generation model (e.g., diffusion model, GAN, VQ-VAE, etc.). Examples of input to the image generation model include prompts such as “depict the new product design with market needs as the background” or “illustrate the process of scheduling a meeting.” The image generation model outputs RGB images including background information (for example, a three-dimensional tensor of 512×512 pixels) based on these prompts. Examples of output include “illustration combining the new product and market graph” or “illustration of a meeting room with a calendar in the background.” The generation unit can optimize the quality and background representation of the generated illustrations by pre-training or fine-tuning the weight parameters of the image generation model according to the domain of the meeting or the preferences of the participants. As a technical effect, the generation unit achieves advanced information presentation reflecting context and background information compared to conventional simple illustration generation, thereby improving participants' understanding and the quality of discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can estimate the emotions of meeting participants and adjust the colors of the illustration based on the estimated emotions. For example, the generation unit estimates the emotions of meeting participants and adjusts the colors of the illustration based on the estimated emotions. Specific methods and criteria for color adjustment may include, for example, changing hue, adjusting saturation, and the like, but are not limited thereto. For example, if a meeting participant is relaxed, an illustration with soft colors is generated. If a meeting participant is excited, an illustration with vivid colors is generated. If a meeting participant is nervous, an illustration with calm colors is generated. By adjusting the colors of the illustration according to the emotions of meeting participants, participants' understanding can be deepened. Emotion estimation is realized using, for example, an emotion engine or a generation AI with emotion estimation functionality. The generation AI may be, for example, a text generation AI (e.g., LLM) or a multimodal generation AI, but is not limited thereto. Some or all of the above-described processing in the generation unit may be performed using AI or may be performed without using AI. For example, the generation unit may input emotion data of meeting participants to the generation AI and have the generation AI execute the color adjustment of the illustration. Specifically, the generation unit acquires input data such as speech audio, facial images, and biometric data (e.g., audio waveform, facial image, heart rate, etc.) of meeting participants. Examples of input include a 1-second audio waveform (16,000 samples), a facial image (128×128 pixel RGB image), and voice tone features during speech (pitch, energy, etc.). An emotion estimation model (e.g., multimodal neural network) outputs emotion labels (e.g., “nervous,” “relaxed,” “excited”) or emotion scores (continuous values from 0.0 to 1.0) from these inputs. Examples of output include “nervousness level 0.8,” “relaxation level 0.2,” and so on. The generation unit dynamically adjusts prompts and color parameters (e.g., hue, saturation, brightness, etc.) for the image generation model (e.g., diffusion model, GAN, VQ-VAE, etc.) according to the estimated emotion values. For example, if the relaxation level is high, pastel colors and low saturation are specified; if the excitement level is high, vivid colors and high saturation are specified; if the nervousness level is high, calm colors and low brightness are specified. The image generation model outputs RGB images (for example, a three-dimensional tensor of 512×512 pixels) based on these prompts. Examples of output include “softly colored illustration,” “vividly colored illustration,” “calmly colored illustration,” and so on. As a technical effect, the generation unit achieves flexible color expression according to the emotional state of participants compared to conventional uniform color generation, thereby improving the progress and quality of discussions in meetings. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can generate an animation based on the content of the text data and provide dynamic visuals. For example, the generation unit generates an animation based on the content of the text data and provides dynamic visuals. Specific methods and criteria for animation generation may include, for example, frame rate, animation length, and the like, but are not limited thereto. For example, a simple animation can be generated based on the content of the text data. An animation related to the theme of the meeting can be generated. An animation related to the content of the meeting can also be generated. By generating an animation based on the content of the text data, dynamic visuals can be provided. Some or all of the above-described processing in the generation unit may be performed using a generation AI or may be performed without using a generation AI. For example, the generation unit may input text data to the generation AI and have the generation AI execute the animation generation. Specifically, the generation unit inputs the text data obtained from the speech recognition unit to a natural language processing module (e.g., transformer-based large language model) and performs context analysis and keyword extraction. Examples of input include natural language text such as “Let's discuss the design of the new product” or “Let's decide the schedule for the next meeting.” The generation unit generates prompts for the animation generation model (e.g., time-series diffusion model, GAN-based video generation model, etc.) including scene descriptions and motion instructions for each frame based on the extracted information. The animation generation model outputs consecutive frame images (for example, 30 frames per second, a total of 5 seconds of RGB image tensors) based on these prompts. Examples of output include “animation of a new product appearing while rotating” or “animation of participants speaking in a meeting room.” The generation unit can dynamically adjust the frame rate, length, and motion patterns of the animation according to the theme or progress of the meeting. As a technical effect, the generation unit achieves improved information transmission efficiency and participant attention through dynamic visual expression compared to conventional static illustration generation, thereby improving the progress and quality of discussions in meetings. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The generation unit can generate a 3D model based on the content of the text data and provide three-dimensional visuals. For example, the generation unit generates a 3D model based on the content of the text data and provides three-dimensional visuals. Specific methods and criteria for 3D model generation may include, for example, modeling techniques, rendering methods, and the like, but are not limited thereto. For example, a simple 3D model can be generated based on the content of the text data. A 3D model related to the theme of the meeting can be generated. A 3D model related to the content of the meeting can also be generated. By generating a 3D model based on the content of the text data, three-dimensional visuals can be provided. Some or all of the above-described processing in the generation unit may be performed using a generation AI or may be performed without using a generation AI. For example, the generation unit may input text data to the generation AI and have the generation AI execute the generation of the 3D model. Specifically, the generation unit inputs the text data obtained from the speech recognition unit to a natural language processing module (e.g., transformer-based large language model) and performs context analysis and keyword extraction. Examples of input include natural language text such as “Let's discuss the design of the new product” or “Let's decide the schedule for the next meeting.” The generation unit generates prompts for the 3D model generation model (e.g., neural rendering model, voxel-based generation model, etc.) including shape, structure, and texture information based on the extracted information. The 3D model generation model outputs 3D mesh data (e.g., vertex coordinate arrays, face information, texture images, etc.) based on these prompts. Examples of output include “3D model of the new product” or “three-dimensional model of the meeting room.” The generation unit can dynamically adjust the resolution, texture, and rendering method of the 3D model according to the theme of the meeting or the requests of the participants. Furthermore, the generated 3D model can be interactively displayed and operated on participants' devices using WebGL or a dedicated 3D viewer. As a technical effect, the generation unit achieves three-dimensional information presentation and promotion of spatial understanding compared to conventional 2D illustration generation, thereby improving the progress and quality of discussions in meetings. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can estimate the emotions of meeting participants and adjust the method of displaying illustrations based on the estimated emotions. For example, the display unit estimates the emotions of meeting participants and adjusts the method of displaying illustrations according to the estimated emotions. Criteria and methods for adjusting the display method may include, for example, changing the display position or display size, but are not limited thereto. For instance, if meeting participants are relaxed, the display unit displays illustrations with a soft touch. If participants are excited, it can display illustrations with vivid colors. If participants are tense, it can display illustrations with calm tones. By adjusting the method of displaying illustrations according to the emotions of meeting participants, the participants' understanding can be deepened. Emotion estimation is realized, for example, by using an emotion engine or an emotion estimation function implemented by generative AI. Generative AI may include, for example, text generation AI (such as LLM) or multimodal generative AI, but is not limited thereto. Some or all of the above-described processing in the display unit may be performed using AI or without using AI. For example, the display unit may input emotion data of meeting participants to generative AI and have the generative AI execute the adjustment of the illustration display method. Specifically, the display unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “tense,” “relaxed,” “excited”) and emotion scores (continuous values from 0.0 to 1.0) from these inputs. Examples of output include “tension level 0.8,” “relaxation level 0.2,” and so on. The display unit dynamically adjusts parameters such as illustration display position (e.g., center of the screen, side panel), display size (e.g., large, medium, small), and color correction (e.g., vivid, calm) according to the estimated emotion values. For example, if the relaxation level is high, a soft-touch illustration is displayed largely in the center; if the excitement level is high, a vivid illustration is emphasized; if the tension level is high, a calm illustration is displayed modestly. As a technical effect, compared to conventional uniform display, the display unit realizes flexible information presentation according to the emotional state of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can adjust the display timing of illustrations according to the progress of the meeting when displaying illustrations. For example, the display unit adjusts the display timing of illustrations according to the progress of the meeting. Criteria and methods for adjusting display timing may include, for example, the progress of the meeting or the timing of statements, but are not limited thereto. For instance, the display unit displays illustrations in accordance with important statements at the beginning of the meeting. It can also display illustrations in line with key points of discussion in the middle of the meeting, or in accordance with conclusions or decisions at the end of the meeting. By adjusting the display timing of illustrations according to the progress of the meeting, important information can be provided at appropriate times. Some or all of the above-described processing in the display unit may be performed using generative AI or without using generative AI. For example, the display unit may input meeting progress data to generative AI and have the generative AI execute the adjustment of display timing. Specifically, the display unit receives meeting progress data (e.g., agenda start/end timestamps, speaker lists, meeting progress logs, etc.) and illustration images output from the generation unit as input. Examples of input include progress labels such as “meeting start: explanation of new product concept,” “mid-meeting: discussion of technical issues,” “end of meeting: confirmation of decisions,” and corresponding illustration images. The display unit uses a progress analysis module (e.g., time-series analysis model, rule-based engine) to calculate the optimal illustration display timing for each agenda item or statement timing. For example, it immediately displays related illustrations right after important statements, and presents summary illustrations when key points or conclusions are reached. The display unit dynamically adjusts the illustration display timing in real time so that participants can visually grasp important information at appropriate times. As a technical effect, compared to conventional static material distribution or manual display, the display unit realizes flexible information presentation according to the progress and flow of the meeting, thereby promoting efficient minutes creation and decision-making. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can customize the display layout according to the theme of the meeting when displaying illustrations. For example, the display unit customizes the display layout according to the theme of the meeting when displaying illustrations. Methods and criteria for customizing the display layout may include, for example, layout templates and customization options, but are not limited thereto. For instance, if the theme of the meeting is “marketing strategy,” the display unit displays related illustrations. If the theme is “new product development,” it can display related illustrations. If the theme is “budget planning,” it can display related illustrations. By customizing the display layout according to the theme of the meeting, participants' understanding can be deepened. Some or all of the above-described processing in the display unit may be performed using generative AI or without using generative AI. For example, the display unit may input meeting theme data to generative AI and have the generative AI execute the customization of the display layout. Specifically, the display unit receives meeting theme data (e.g., “marketing strategy,” “new product development,” “budget planning,” etc.) and illustration images output from the generation unit as input. Examples of input include “meeting theme: marketing strategy” and “illustration image: market analysis graph.” The display unit uses a layout customization module (e.g., template matching algorithm, rule-based engine) to automatically select the optimal layout template and customization options (e.g., image placement, size, color tone, annotation position, etc.) for the theme. For example, for the “marketing strategy” theme, graphs and charts are placed large in the center; for the “new product development” theme, product images are emphasized; for the “budget planning” theme, numerical data and tables are placed in side panels. The display unit displays illustrations with the customized layout so that participants can intuitively grasp information according to the theme. As a technical effect, compared to conventional uniform layout display, the display unit realizes flexible information presentation according to the theme and content of the meeting, thereby promoting efficient minutes creation and decision-making. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can estimate the emotions of meeting participants and adjust the display size of illustrations based on the estimated emotions. For example, the display unit estimates the emotions of meeting participants and adjusts the display size of illustrations according to the estimated emotions. Criteria and methods for adjusting display size may include, for example, adjustment according to screen size or participants' visual preferences, but are not limited thereto. For instance, if meeting participants are relaxed, the display unit displays soft-touch illustrations in a large size. If participants are excited, it can display vivid illustrations in a large size. If participants are tense, it can display calm illustrations in a small size. By adjusting the display size of illustrations according to the emotions of meeting participants, participants' understanding can be deepened. Emotion estimation is realized, for example, by using an emotion engine or an emotion estimation function implemented by generative AI. Generative AI may include, for example, text generation AI (such as LLM) or multimodal generative AI, but is not limited thereto. Some or all of the above-described processing in the display unit may be performed using AI or without using AI. For example, the display unit may input emotion data of meeting participants to generative AI and have the generative AI execute the adjustment of illustration display size. Specifically, the display unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “tense,” “relaxed,” “excited”) and emotion scores (continuous values from 0.0 to 1.0) from these inputs. Examples of output include “tension level 0.8,” “relaxation level 0.2,” and so on. The display unit dynamically adjusts parameters such as illustration display size (e.g., large, medium, small), display position, and color correction according to the estimated emotion values. For example, if the relaxation level is high, a soft-touch illustration is displayed in a large size; if the excitement level is high, a vivid illustration is displayed in a large size; if the tension level is high, a calm illustration is displayed in a small size. As a technical effect, compared to conventional uniform size display, the display unit realizes flexible information presentation according to the emotional state of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can select the optimal display method for illustrations by considering the device information of meeting participants when displaying illustrations. For example, the display unit selects the optimal display method for illustrations by considering the device information of meeting participants. Specific types and methods of considering device information may include, for example, screen resolution and device type, but are not limited thereto. For instance, if a meeting participant is using a smartphone, the display unit provides a display method adapted to the screen size. If a participant is using a tablet, it can provide a display method optimized for a large screen. If a participant is using a laptop, it can provide a display method adapted to the screen size. By selecting the optimal display method for illustrations according to the device information of meeting participants, participants' understanding can be deepened. Some or all of the above-described processing in the display unit may be performed using generative AI or without using generative AI. For example, the display unit may input device information of meeting participants to generative AI and have the generative AI execute the selection of the optimal display method. Specifically, the display unit acquires device information of meeting participants (e.g., device type, screen resolution, OS version, network bandwidth, etc.) as input data. Examples of input include “device type: smartphone, resolution: 1080×1920,” “device type: tablet, resolution: 2048×1536,” “device type: laptop, resolution: 1920×1080,” and so on. The display unit uses a device optimization module (e.g., responsive design engine, template matching algorithm) to automatically select the optimal image size, layout, resolution, and interaction method (e.g., touch operation, mouse operation, etc.) for each device. For example, on a smartphone, images are resized vertically; on a tablet, they are displayed in high resolution; on a laptop, multiple illustrations are displayed in parallel. The display unit presents illustrations using the optimized display method so that participants can comfortably grasp information regardless of the device. As a technical effect, compared to conventional uniform display, the display unit realizes flexible information presentation adapted to device diversity, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can track the gaze of meeting participants and adjust the display position of illustrations according to the gaze when displaying illustrations. For example, the display unit tracks the gaze of meeting participants and adjusts the display position of illustrations according to the gaze. Specific methods and criteria for gaze tracking may include, for example, gaze tracking technology and gaze data analysis methods, but are not limited thereto. For instance, the display unit tracks the gaze of meeting participants and displays illustrations in the direction the gaze is directed. If the gaze of meeting participants is concentrated on a specific point, it can display illustrations at that point. If the gaze of meeting participants moves, it can adjust the display position of illustrations according to the movement of the gaze. By adjusting the display position of illustrations according to the gaze of meeting participants, participants' understanding can be deepened. Some or all of the above-described processing in the display unit may be performed using generative AI or without using generative AI. For example, the display unit may input gaze data of meeting participants to generative AI and have the generative AI execute the adjustment of display position. Specifically, the display unit acquires gaze data of meeting participants (e.g., gaze coordinates, gaze movement speed, gaze concentration, etc.) as input data. Examples of input include “gaze coordinates: center of screen (540,960),” “gaze coordinates: upper right of screen (1620,200),” “gaze movement speed: 50 pixels/sec,” and so on. Using a gaze tracking module (e.g., camera-based gaze tracking algorithm, wearable gaze sensor), the display unit detects in real time the direction the participants' gaze is directed or the point of concentration. The display unit dynamically adjusts parameters such as illustration display position (e.g., automatic movement to the area where gaze is concentrated), display size, and emphasis according to the detected gaze information. For example, if the gaze is concentrated in the center of the screen, the illustration is enlarged and displayed in the center; if the gaze is dispersed, multiple illustrations are arranged in a distributed manner. As a technical effect, compared to conventional fixed display, the display unit realizes flexible information presentation according to the gaze trends of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The system according to the embodiment is not limited to the above examples and can be variously modified as follows. Specifically, the system can flexibly introduce additional functions and extended configurations to each module: the speech recognition unit, the generation unit, and the display unit. For example, the speech recognition unit can be supplemented with multilingual speech recognition, real-time translation functions, speaker identification, and statement summarization functions. The generation unit can be supplemented with animation generation, 3D model generation, data visualization (graph/chart generation), dynamic adjustment of style, color, and composition based on emotion estimation, simultaneous generation and optimal selection of multiple illustrations, and automatic addition of background information by linking with external knowledge bases. The display unit can be supplemented with functions such as optimized display based on participants' device information and gaze data, dynamic adjustment of layout, timing, size, and speed according to meeting progress and participants' emotions, and interactive operations (zooming, annotation addition, feedback collection). With these extensions, the system can be applied to a wide variety of use cases, including corporate meetings, educational settings, international conferences, medical conferences, and creative workshops, and demonstrates overwhelming flexibility, scalability, and technical effects (improved information transmission efficiency, accelerated decision-making, increased participant satisfaction) compared to conventional single-function systems. Furthermore, improvements in computer technology itself are achieved through data flow and API integration between modules, cloud distributed processing, and high-speed parallel computation using GPU clusters.

The speech recognition unit can translate the statements of meeting participants in real time and generate text data in multiple languages. For example, content spoken in English during a meeting can be translated into Japanese or French, and text data in each language can be generated. When meeting participants speak different languages, the speech recognition unit can translate each participant's statements into a common language and generate text data. This enables smooth communication among participants who speak different languages. Some or all of the above-described processing in the speech recognition unit may be performed using translation AI or without using translation AI. For example, the speech recognition unit may input statement content to translation AI and have the translation AI execute translation and text data generation. Specifically, the speech recognition unit acquires speech audio data of meeting participants (e.g., English audio waveform, French audio waveform, etc.) via high-sensitivity microphone arrays or networks, extracts acoustic features (e.g., Mel-frequency cepstral coefficients, spectrograms, etc.), and inputs them to a speech recognition model using convolutional neural networks or recurrent neural networks. Input data may include a one-second audio waveform sampled at 16 kHz (a one-dimensional array of 16,000 samples) or a spectrogram image (a two-dimensional tensor of 128×128 pixels). The speech recognition model outputs the statement content as a character string sequence in the original language from these inputs. Examples of output include “Let's discuss the new product design.” or “Discutons du calendrier de la prochaine réunion.” Next, the speech recognition unit inputs the obtained text data to a translation model (e.g., transformer-based neural machine translation model) and executes translation into specified multiple languages. Examples of input to the translation model include “Let's discuss the new product design.”→“ [symbol] [symbol] ” (Japanese), “Discutons du calendrier de la prochaine réunion.”→“Let's discuss the schedule of the next meeting.” (English), and so on. The translation model outputs text data in each language (e.g., Japanese, English, French, etc.). Examples of output include “ [symbol] ” and “Parlons de la conception du nouveau produit.” The speech recognition unit collaborates with the display unit to realize simultaneous distribution of multilingual text and automatic interface switching so that translation results are displayed in real time in the optimal language for each meeting participant. As a technical effect, compared to conventional single-language minutes or manual translation, the speech recognition unit realizes real-time and multilingual information sharing, greatly improving communication efficiency in international conferences and multinational teams. Specific application fields include meetings of global companies, international academic conferences, multilingual classes in educational settings, and medical conferences. Through these configurations and processing procedures, the present invention not only automates human tasks but also contributes to the advancement of computer technology itself and the creation of new information processing methods.

The generation unit can dynamically change the style of illustrations according to the progress of the meeting. For example, the generation unit generates simple illustrations at the beginning of the meeting, detailed illustrations in the middle, and illustrations emphasizing key points at the end. This enables the provision of appropriate visual information according to the progress of the meeting. Some or all of the above-described processing in the generation unit may be performed using progress analysis AI or without using progress analysis AI. For example, the generation unit may input meeting progress data to progress analysis AI and have the progress analysis AI execute the style change of illustrations. Specifically, the generation unit receives meeting progress data (e.g., agenda start/end timestamps, speaker lists, meeting progress logs, etc.) and text data obtained from the speech recognition unit as input. Examples of input include progress labels such as “meeting start: explanation of new product concept,” “mid-meeting: discussion of technical issues,” “end of meeting: confirmation of decisions,” and corresponding text data. A progress analysis model (e.g., time-series analysis model, rule-based engine) determines the phase of the meeting from these data and decides the optimal illustration style (e.g., simple, detailed, key point emphasis) for each phase. The generation unit dynamically adjusts prompts and style parameters (e.g., line thickness, color tone, presence of annotations, etc.) for image generation models (e.g., diffusion models, GAN, VQ-VAE, etc.) based on the determination results. For example, at the beginning of the meeting, simple line-drawing illustrations are generated; in the middle, detailed illustrations with annotations; at the end, highlighted illustrations emphasizing key points. The image generation model outputs RGB images (e.g., 512×512 pixel three-dimensional tensors) from these prompts. Examples of output include “simple new product illustration,” “detailed technical issue illustration,” and “key point emphasis illustration.” As a technical effect, compared to conventional uniform style generation, the generation unit realizes flexible information presentation according to the progress of the meeting, thereby promoting efficient minutes creation and decision-making. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can track the gaze of meeting participants and adjust the method of displaying illustrations according to the degree of gaze concentration. For example, if participants' gaze is concentrated on a specific illustration, the display unit enlarges that illustration. If the gaze is dispersed, it can display multiple illustrations simultaneously. This enables the provision of appropriate visual information according to the participants' gaze. Some or all of the above-described processing in the display unit may be performed using gaze tracking AI or without using gaze tracking AI. For example, the display unit may input gaze data to gaze tracking AI and have the gaze tracking AI execute the adjustment of the display method. Specifically, the display unit acquires gaze data of meeting participants (e.g., gaze coordinates, gaze movement speed, gaze concentration, etc.) as input data. Examples of input include “gaze coordinates: center of screen (540,960),” “gaze concentration: 0.9,” “gaze dispersion: 0.2,” and so on. Using a gaze tracking module (e.g., camera-based gaze tracking algorithm, wearable gaze sensor), the display unit detects in real time whether participants' gaze is concentrated on a specific illustration or dispersed among multiple illustrations. The display unit dynamically adjusts the method of displaying illustrations (e.g., enlargement, split display, emphasis, etc.) according to the detected gaze information. For example, if the gaze is concentrated on a specific illustration, that illustration is enlarged; if the gaze is dispersed, multiple illustrations are displayed simultaneously. As a technical effect, compared to conventional fixed display, the display unit realizes flexible information presentation according to the gaze trends of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The speech recognition unit can summarize statement content according to the progress of the meeting and generate summary text. For example, at the beginning of the meeting, statement content is recorded in detail; in the middle, key points are extracted and summarized; at the end, conclusions and decisions are summarized and text data is generated. This enables efficient grasp of important information according to the progress of the meeting. Some or all of the above-described processing in the speech recognition unit may be performed using summarization AI or without using summarization AI. For example, the speech recognition unit may input statement content to summarization AI and have the summarization AI execute the generation of summary text. Specifically, the speech recognition unit receives meeting progress data (e.g., agenda start/end timestamps, speaker lists, meeting progress logs, etc.) and real-time speech audio data as input. Examples of input include progress labels such as “meeting start: explanation of new product concept,” “mid-meeting: discussion of technical issues,” “end of meeting: confirmation of decisions,” and corresponding audio waveform data. The speech recognition unit inputs statement content converted to text by a speech recognition model to a summarization model (e.g., transformer-based extractive/abstractive summarization model) and dynamically adjusts the degree of summarization (e.g., detailed, key point extraction, conclusion summary) according to the progress. Examples of output include “The concept of the new product is decided as proposal A,” “Technical issues are resolved with proposal B,” and so on. The speech recognition unit links the summary text to the display unit or minutes creation module so that participants can efficiently grasp important information. As a technical effect, compared to conventional full-text recording or manual summarization, the speech recognition unit realizes flexible information presentation according to the progress and flow of the meeting, thereby promoting efficient minutes creation and decision-making. Specific application fields include corporate planning meetings, R&D meetings, group work in educational settings, and multilingual support in international conferences. Through these configurations and processing procedures, the present invention not only automates human tasks but also contributes to the advancement of computer technology itself and the creation of new information processing methods.

The generation unit can generate illustrations that include related data and graphs according to the theme of the meeting. For example, if the theme of the meeting is “sales analysis,” the generation unit generates illustrations that include sales data and graphs. If the theme is “project progress,” it can generate illustrations that include graphs showing progress. This enables the provision of visually easy-to-understand information according to the theme of the meeting. Some or all of the above-described processing in the generation unit may be performed using data analysis AI or without using data analysis AI. For example, the generation unit may input theme data to data analysis AI and have the data analysis AI execute the generation of illustrations including related data and graphs. Specifically, the generation unit receives meeting theme data (e.g., “sales analysis,” “project progress,” etc.) and related numerical data or time-series data (e.g., sales trends, progress rates, achievement targets, etc.) as input. Examples of input include “sales data: monthly sales from January to December 2023,” “progress data: completion rate of each task,” and so on. A data analysis model (e.g., time-series analysis model, clustering algorithm, regression analysis model, etc.) extracts major trends and features (e.g., sales increase/decrease trends, progress delays, etc.) from these data and visualizes them using a graph generation module (e.g., bar graph, line graph, pie chart, etc.). The generation unit uses graph images and data summaries as prompts for image generation models (e.g., diffusion models, GAN, VQ-VAE, etc.) and generates composite images combining illustrations related to the theme and graphs (e.g., 512×512 pixel RGB image tensor). Examples of output include “new product illustration with sales trend graph in the background,” “progress status graph and illustration of project members,” and so on. As a technical effect, compared to conventional manual graph creation or static material distribution, the generation unit realizes improved information transmission efficiency and accelerated decision-making through automatic linkage of data analysis and visual generation. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The speech recognition unit can estimate the emotions of meeting participants and evaluate the importance of statement content based on the estimated emotions. For example, if a participant is excited, the speech recognition unit judges the statement content as important and preferentially converts it into text data. If a participant is relaxed, the statement content is treated as having normal importance. This enables the evaluation of the importance of statement content according to participants' emotions and the provision of appropriate information. Emotion estimation is realized, for example, by using an emotion engine or an emotion estimation function implemented by generative AI. Some or all of the above-described processing in the speech recognition unit may be performed using emotion estimation AI or without using emotion estimation AI. For example, the speech recognition unit may input emotion data to emotion estimation AI and have the emotion estimation AI execute the evaluation of statement importance. Specifically, the speech recognition unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “excited,” “relaxed”) and emotion scores (continuous values from 0.0 to 1.0) from these inputs. Examples of output include “excitement level 0.9,” “relaxation level 0.1,” and so on. The speech recognition unit calculates an importance score for statement content according to the estimated emotion values and preferentially converts statements with high importance into text. For example, if the excitement level is high, the statement is judged as important and converted into text in real time and sent to the display unit. As a technical effect, compared to conventional uniform importance evaluation, the speech recognition unit realizes flexible information extraction according to the emotional state of participants, thereby improving the progress and quality of meetings and discussions. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The generation unit can estimate the emotions of meeting participants and adjust the level of detail of illustrations based on the estimated emotions. For example, if a participant is excited, the generation unit generates detailed illustrations to provide abundant information. If a participant is relaxed, it can generate simple illustrations to provide concise information. This enables the adjustment of the level of detail of illustrations according to participants' emotions and the provision of appropriate information. Emotion estimation is realized, for example, by using an emotion engine or an emotion estimation function implemented by generative AI. Some or all of the above-described processing in the generation unit may be performed using emotion estimation AI or without using emotion estimation AI. For example, the generation unit may input emotion data to emotion estimation AI and have the emotion estimation AI execute the adjustment of illustration detail level. Specifically, the generation unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “excited,” “relaxed”) and emotion scores (continuous values from 0.0 to 1.0) from these inputs. Examples of output include “excitement level 0.9,” “relaxation level 0.1,” and so on. The generation unit dynamically adjusts prompts and detail parameters (e.g., line density, presence of annotations, number of colors, etc.) for image generation models (e.g., diffusion models, GAN, VQ-VAE, etc.) according to the estimated emotion values. For example, if the excitement level is high, detailed illustrations with annotations are generated; if the relaxation level is high, simple line drawings or illustrations with fewer colors are generated. The image generation model outputs RGB images (e.g., 512×512 pixel three-dimensional tensors) from these prompts. Examples of output include “detailed technical illustration,” “simple concept illustration,” and so on. As a technical effect, compared to conventional uniform detail generation, the generation unit realizes flexible information presentation according to the emotional state of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The display unit can estimate the emotions of meeting participants and adjust the display speed of illustrations based on the estimated emotions. For example, if a participant is excited, the display unit quickly displays illustrations to provide information rapidly. If a participant is relaxed, it can display illustrations slowly to provide information calmly. This enables the adjustment of the display speed of illustrations according to participants' emotions and the provision of appropriate information. Emotion estimation is realized, for example, by using an emotion engine or an emotion estimation function implemented by generative AI. Some or all of the above-described processing in the display unit may be performed using emotion estimation AI or without using emotion estimation AI. For example, the display unit may input emotion data to emotion estimation AI and have the emotion estimation AI execute the adjustment of illustration display speed. Specifically, the display unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “excited,” “relaxed”) and emotion scores (continuous values from 0.0 to 1.0) from these inputs. Examples of output include “excitement level 0.9,” “relaxation level 0.1,” and so on. The display unit dynamically adjusts parameters such as illustration display speed (e.g., immediate display, gradual display), animation speed, and display delay time according to the estimated emotion values. For example, if the excitement level is high, illustrations are displayed quickly; if the relaxation level is high, illustrations are displayed slowly. As a technical effect, compared to conventional uniform display speed, the display unit realizes flexible information presentation according to the emotional state of participants, thereby improving the progress and quality of meetings and discussions. Specific application fields include corporate planning meetings, R&D meetings, group work in educational settings, and multilingual visualization in international conferences. Through these configurations and processing procedures, the present invention not only automates human tasks but also contributes to the advancement of computer technology itself and the creation of new information presentation methods.

The speech recognition unit can estimate the emotions of meeting participants and adjust the tone of statement content based on the estimated emotions. For example, if a participant is tense, the speech recognition unit converts the statement content into text data with a soft tone. If a participant is excited, it can convert the statement content into text data with an emphasized tone. This enables the adjustment of the tone of statement content according to participants' emotions and the provision of appropriate information. Emotion estimation is realized, for example, by using an emotion engine or an emotion estimation function implemented by generative AI. Some or all of the above-described processing in the speech recognition unit may be performed using emotion estimation AI or without using emotion estimation AI. For example, the speech recognition unit may input emotion data to emotion estimation AI and have the emotion estimation AI execute the adjustment of statement tone. Specifically, the speech recognition unit acquires input data such as speech audio, facial images, and biometric data (e.g., audio waveforms, facial images, heart rate, etc.) of meeting participants. Examples of input include a one-second audio waveform (16,000 samples), a facial image (128×128 pixel RGB image), and speech tone features (pitch, energy, etc.) at the time of utterance. An emotion estimation model (e.g., multimodal neural network) outputs emotion labels (e.g., “tense,” “excited”) and emotion scores (continuous values from 0.0 to 1.0) from these inputs. Examples of output include “tension level 0.8,” “excitement level 0.9,” and so on. The speech recognition unit uses a tone conversion module (e.g., style conversion model, emphasis word insertion algorithm, etc.) at the time of text conversion to dynamically adjust the tone of statement content (e.g., soft expression, emphasized expression, etc.) according to the estimated emotion values. For example, if the tension level is high, the statement is converted to a polite and soft expression; if the excitement level is high, the statement is converted to an expression with emphasis words or exclamation marks. Examples of output include “We would like to propose,” “This is very important!” and so on. As a technical effect, compared to conventional uniform tone conversion, the speech recognition unit realizes flexible information presentation according to the emotional state of participants, thereby improving the progress and quality of meetings and discussions. Specific application fields include corporate planning meetings, R&D meetings, group discussions in educational settings, and multilingual support in international conferences. Through these configurations and processing procedures, the present invention not only automates human tasks but also contributes to the advancement of computer technology itself and the creation of new information processing methods.

The generation unit can estimate the emotions of meeting participants and adjust the composition of illustrations based on the estimated emotions. For example, if a participant is relaxed, the generation unit generates illustrations with a broad composition. If a participant is excited, it can generate illustrations with a concentrated composition. This enables the adjustment of illustration composition according to participants' emotions and the provision of appropriate information. Emotion estimation is realized, for example, by using an emotion engine or an emotion estimation function implemented by generative AI. Some or all of the above-described processing in the generation unit may be performed using emotion estimation AI or without using emotion estimation AI. For example, the generation unit may input emotion data to emotion estimation AI and have the emotion estimation AI execute the adjustment of illustration composition. Specifically, the generation unit simultaneously acquires speech audio data of meeting participants (e.g., one-second audio waveform of 16,000 samples), facial images (128×128 pixel RGB images), and biometric data (e.g., time-series numerical arrays such as heart rate, skin conductance response), and inputs these to a multimodal neural network. Examples of input include “audio waveform: 16,000 samples,” “facial image: 128×128 pixels,” “heart rate: 80 bpm,” and so on. The emotion estimation model combines image feature extraction by convolutional neural networks, time-series biometric data analysis by recurrent neural networks, and acoustic feature extraction (e.g., Mel-frequency cepstral coefficients, pitch, energy, etc.) to output emotion labels (e.g., “relaxed,” “excited,” “tense”) and emotion scores (continuous values from 0.0 to 1.0). Examples of output include “relaxation level 0.7,” “excitement level 0.3,” and so on. The generation unit dynamically adjusts prompts and composition parameters (e.g., field of view, subject arrangement, depth, distribution of focal points, etc.) for image generation models (e.g., diffusion models, GAN, VQ-VAE, etc.) according to the estimated emotion values. For example, if the relaxation level is high, a wide field of view and dispersed arrangement are specified; if the excitement level is high, a central concentrated composition or close-up of the subject is specified. The image generation model outputs RGB images (e.g., 512×512 pixel three-dimensional tensors) from these prompts. Examples of output include “broad conference room overview illustration,” “centralized composition illustration with people gathered in the center,” and so on. The generation unit can also automatically optimize composition parameters and perform complex composition control in conjunction with meeting themes, progress, and participant attributes. Furthermore, it is possible to simultaneously generate multiple composition candidates and select the optimal composition using participants' real-time feedback or gaze data. As a technical effect, compared to conventional uniform composition generation, the generation unit realizes flexible visual expression according to participants' emotional state and meeting situation, greatly improving information transmission efficiency, participants' understanding, and satisfaction. Specific application fields include corporate planning meetings, R&D meetings, group work in educational settings, multilingual visualization in international conferences, case explanations in medical conferences, and idea sharing in creative workshops. Through these configurations and processing procedures, the present invention not only automates human tasks but also contributes to the advancement of computer technology itself and the creation of new information presentation methods.

The following is a brief explanation of the processing flow of Example of the Embodiment. Specifically, the system adopts a configuration in which the speech recognition unit, generation unit, and display unit operate in cooperation. First, the system acquires speech audio data of meeting participants (e.g., 16 kHz sampled audio waveform, multi-microphone channel acoustic signals, etc.) in real time via the speech recognition unit, performs acoustic feature extraction (e.g., Mel-frequency cepstral coefficients, spectrogram generation, etc.), and inputs the data to a speech recognition model using convolutional neural networks or recurrent neural networks. The speech recognition model outputs the statement content as text data (e.g., plain text, XML format, JSON format, etc.) from the input audio. Next, the generation unit inputs the text data obtained from the speech recognition unit to a natural language processing module (e.g., transformer-based large language model), and executes context analysis, keyword extraction, emotion estimation, and determination of meeting progress. Based on the extracted information, the generation unit generates prompts for image generation models (e.g., diffusion models, GAN, VQ-VAE, etc.), controls parameters such as style, composition, color, and detail level, and generates illustrations, animations, 3D models, etc., optimized for the meeting content and participants' emotional state. Furthermore, the generation unit can simultaneously generate multiple visual candidates and select the optimal one using participants' feedback or gaze data. Finally, the display unit displays the illustrations and other outputs from the generation unit in real time on the terminals of meeting participants. The display unit dynamically optimizes display layout, timing, size, speed, etc., by considering device information (e.g., screen resolution, device type), gaze tracking data, meeting progress, and participants' emotion values. This enables participants to intuitively grasp important information at appropriate times. As a technical effect, compared to conventional manual minutes creation or static material distribution, the system realizes real-time and diverse information presentation, contributing to the efficiency of meeting progress and decision-making, and improving participants' understanding and satisfaction. Specific application fields include corporate planning meetings, R&D meetings, group work in educational settings, multilingual support in international conferences, medical conferences, and creative workshops. Through these configurations and processing procedures, the present invention not only automates human tasks but also contributes to the advancement of computer technology itself and the creation of new information presentation methods.

Step 1: The speech recognition unit captures the conversation content of the meeting in real time and converts it into text data using speech recognition technology. The conversation content may include business conversations, daily conversations, technical conversations, etc. The text data format may include plain text, XML format, JSON format, etc. Step 2: The generation unit analyzes the text data obtained by the speech recognition unit and generates illustrations based on the content. The generation unit analyzes the text data using generative AI or text generation AI (such as LLM), extracts important information using keyword extraction technology, and generates illustrations based on that information. Step 3: The display unit displays the illustrations generated by the generation unit in real time. The display unit can display the generated illustrations to meeting participants within a few seconds, thereby providing visual information to participants in real time. Specifically, in Step 1, the system inputs audio waveform data (e.g., one-second audio sampled at 16 kHz, multi-channel acoustic signals, etc.) acquired by a high-sensitivity microphone array or via a network to the speech recognition unit, performs acoustic feature extraction (e.g., Mel-frequency cepstral coefficients, spectrogram generation, etc.), and inputs the data to a speech recognition model using convolutional neural networks or recurrent neural networks. The speech recognition model outputs the statement content as text data (e.g., plain text, XML format, JSON format, etc.) from the input audio. Examples of output include “Let's discuss the new product design,” “Let's decide the schedule for the next meeting,” and so on. In Step 2, the generation unit inputs the text data obtained from the speech recognition unit to a natural language processing module (e.g., transformer-based large language model), and executes context analysis, keyword extraction, emotion estimation, and determination of meeting progress. Examples of input include natural language text such as “Let's discuss the new product design” or “Let's decide the schedule for the next meeting.” Based on the extracted information, the generation unit generates prompts for image generation models (e.g., diffusion models, GAN, VQ-VAE, etc.), controls parameters such as style, composition, color, and detail level, and generates illustrations, animations, 3D models, etc., optimized for the meeting content and participants' emotional state. Examples of output include “new product illustration,” “meeting schedule adjustment illustration,” and so on. Furthermore, the generation unit can simultaneously generate multiple visual candidates and select the optimal one using participants' feedback or gaze data. In Step 3, the display unit displays the illustrations and other outputs from the generation unit in real time on the terminals of meeting participants. The display unit dynamically optimizes display layout, timing, size, speed, etc., by considering device information (e.g., screen resolution, device type), gaze tracking data, meeting progress, and participants' emotion values. For example, vertical display on smartphones, high-resolution display on tablets, parallel display of multiple illustrations on laptops, and so on. This enables participants to intuitively grasp important information at appropriate times. As a technical effect, compared to conventional manual minutes creation or static material distribution, the system realizes real-time and diverse information presentation, contributing to the efficiency of meeting progress and decision-making, and improving participants' understanding and satisfaction. Specific application fields include corporate planning meetings, R&D meetings, group work in educational settings, multilingual support in international conferences, medical conferences, and creative workshops. Through these configurations and processing procedures, the present invention not only automates human tasks but also contributes to the advancement of computer technology itself and the creation of new information presentation methods.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements including the speech recognition unit, the generation unit, and the display unit may be implemented by at least one of, for example, the smart device 14 and the data processing apparatus 12. For example, the speech recognition unit is implemented by a microphone 38B and a control unit 46A of the smart device 14, and captures the conversation content of a meeting in real time and converts it into text data. The generation unit is implemented, for example, by a specific processing unit 290 of the data processing apparatus 12, analyzes the obtained text data, and generates an illustration. The display unit is implemented, for example, by a display 40A of the smart device 14, and displays the generated illustration in real time. The correspondence between each unit and the device or control unit is not limited to the above examples, and various modifications are possible.

### Second Embodiment

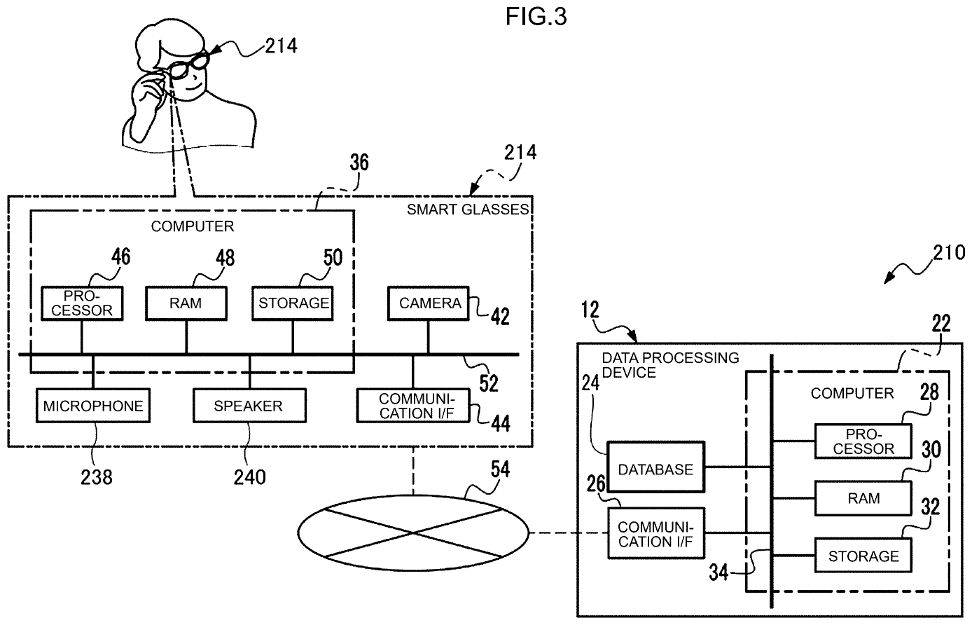

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

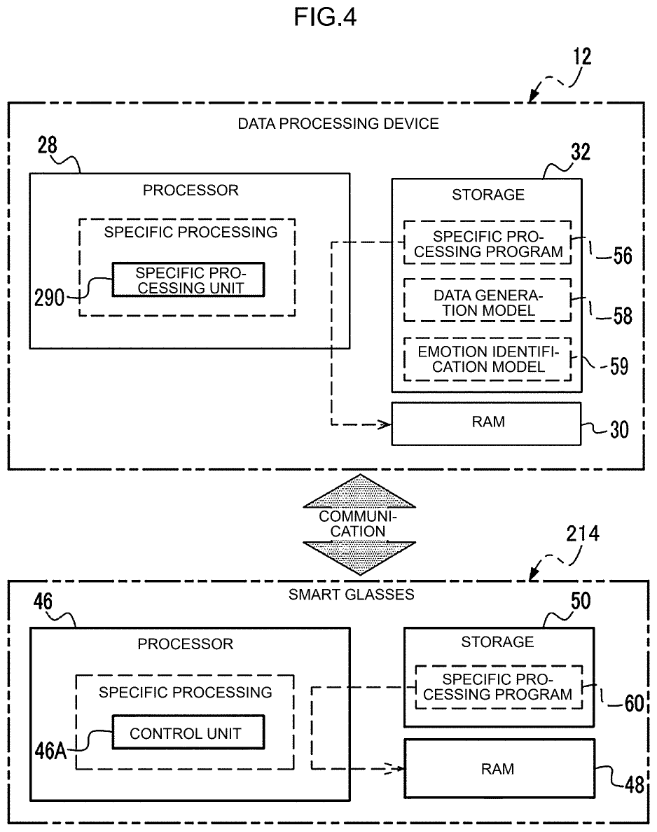

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements including the speech recognition unit, the generation unit, and the display unit may be implemented by at least one of, for example, the smart glasses 214 and the data processing apparatus 12. For example, the speech recognition unit is implemented by a microphone 238 and a control unit 46A of the smart glasses 214, and captures the conversation content of a meeting in real time and converts it into text data. The generation unit is implemented, for example, by a specific processing unit 290 of the data processing apparatus 12, analyzes the obtained text data, and generates an illustration. The display unit is implemented, for example, by a display of the smart glasses 214, and displays the generated illustration in real time. The correspondence between each unit and the device or control unit is not limited to the above examples, and various modifications are possible.

### Third Embodiment

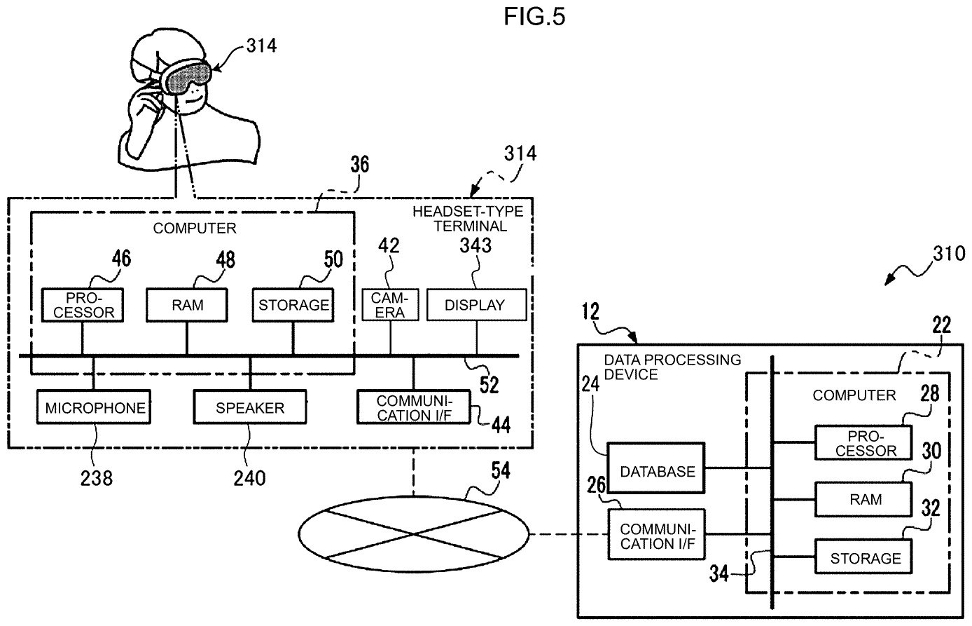

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

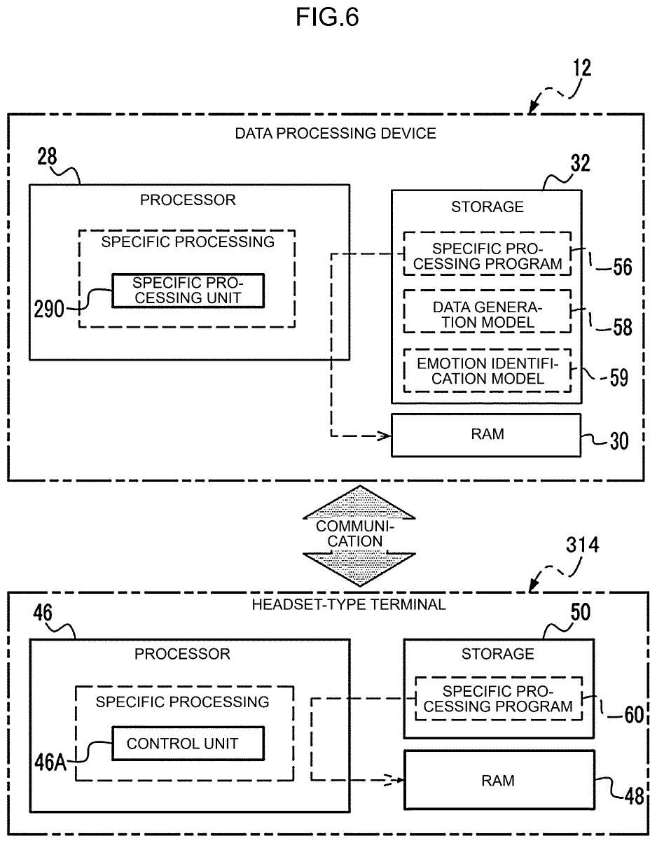

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements including the speech recognition unit, the generation unit, and the display unit may be implemented by at least one of, for example, the headset-type terminal 314 and the data processing apparatus 12. For example, the speech recognition unit is implemented by a microphone 238 and a control unit 46A of the headset-type terminal 314, and captures the conversation content of a meeting in real time and converts it into text data. The generation unit is implemented, for example, by a specific processing unit 290 of the data processing apparatus 12, analyzes the obtained text data, and generates an illustration. The display unit is implemented, for example, by a display 343 of the headset-type terminal 314, and displays the generated illustration in real time. The correspondence between each unit and the device or control unit is not limited to the above examples, and various modifications are possible.

### Fourth Embodiment

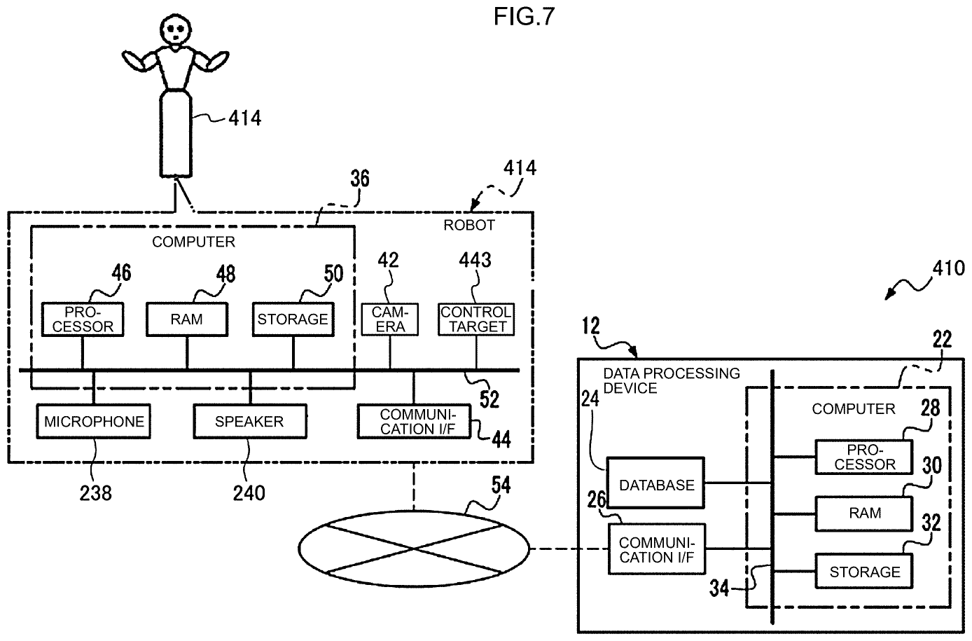

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

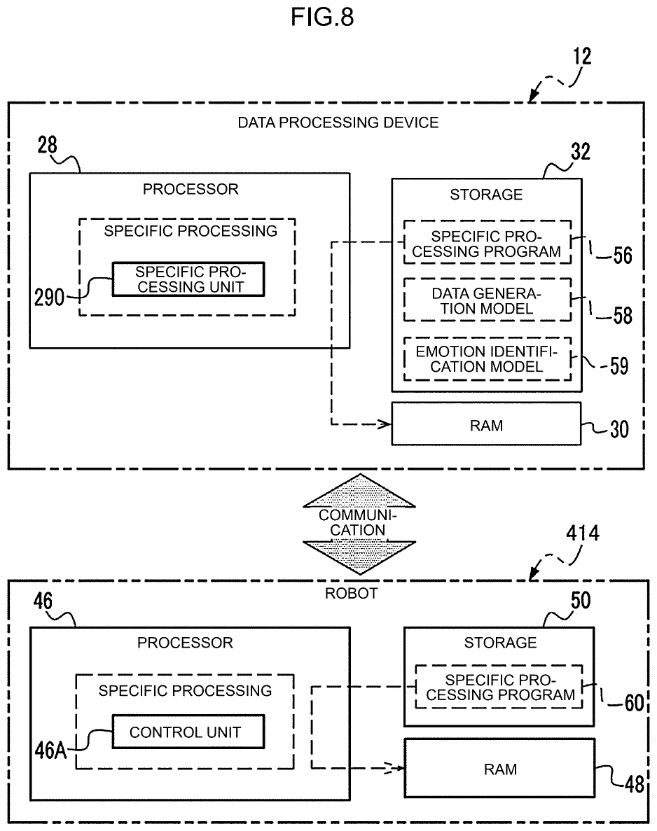

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements including the speech recognition unit, the generation unit, and the display unit may be implemented by at least one of, for example, the robot 414 and the data processing apparatus 12. For example, the speech recognition unit is implemented by a microphone 238 and a control unit 46A of the robot 414, and captures the conversation content of a meeting in real time and converts it into text data. The generation unit is implemented, for example, by a specific processing unit 290 of the data processing apparatus 12, analyzes the obtained text data, and generates an illustration. The display unit is implemented, for example, by a display of the robot 414, and displays the generated illustration in real time. The correspondence between each unit and the device or control unit is not limited to the above examples, and various modifications are possible.

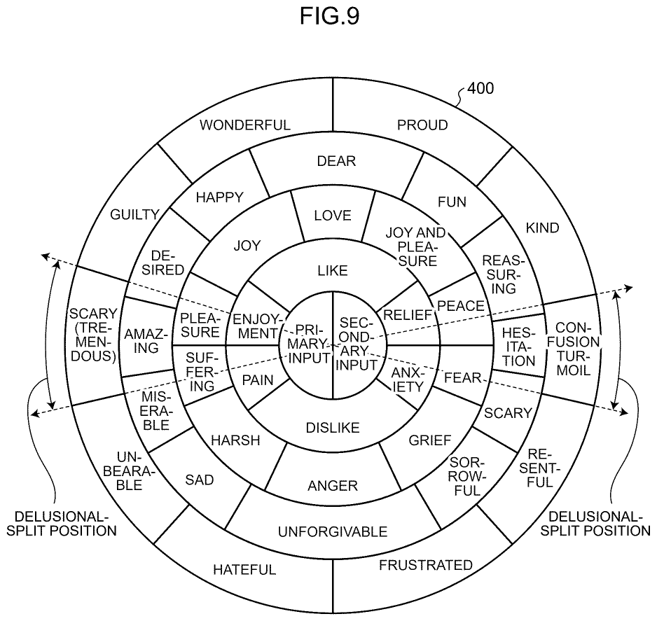

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

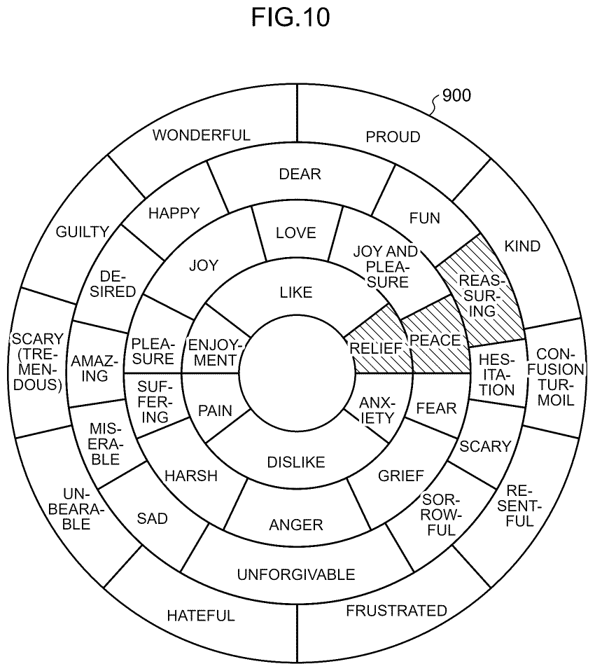

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a speech recognition unit configured to convert conversation content into text data; a generation unit configured to analyze the text data obtained by the speech recognition unit and generate an illustration; and a display unit configured to display the illustration generated by the generation unit.

(Supplementary Note 2) The system according to Supplementary Note 1, wherein the speech recognition unit is configured to capture the conversation content of a meeting in real time and convert it into text data.

(Supplementary Note 3) The system according to Supplementary Note 1, wherein the generation unit is configured to analyze the text data and generate an illustration based on the content thereof.

(Supplementary Note 4) The system according to Supplementary Note 1, wherein the display unit is configured to display the generated illustration in real time.

(Supplementary Note 5) The system according to Supplementary Note 1, wherein the generation unit is configured to generate an image of a specific concept or idea as an illustration.

(Supplementary Note 6) A system configured to enable information to be visually captured through illustrations by the display unit.

(Supplementary Note 7) The system according to Supplementary Note 1, wherein the speech recognition unit is configured to estimate the emotions of meeting participants and adjust the accuracy of speech recognition based on the estimated emotions.

(Supplementary Note 8) The system according to Supplementary Note 1, wherein the speech recognition unit is configured to preferentially convert important statements into text data according to the progress of the meeting.

(Supplementary Note 9) The system according to Supplementary Note 1, wherein the speech recognition unit is configured to emphasize specific keywords and convert them into text data based on the theme or content of the meeting.

(Supplementary Note 10) The system according to Supplementary Note 1, wherein the speech recognition unit is configured to estimate the emotions of meeting participants and adjust the timing of speech recognition based on the estimated emotions.

(Supplementary Note 11) The system according to Supplementary Note 1, wherein the speech recognition unit is configured to enhance noise canceling functionality based on the location of the meeting or environmental sounds.

(Supplementary Note 12) The system according to Supplementary Note 1, wherein the speech recognition unit is configured to analyze the frequency of utterances of meeting participants and apply different speech recognition algorithms for each speaker.

(Supplementary Note 13) The system according to Supplementary Note 1, wherein the generation unit is configured to estimate the emotions of meeting participants and adjust the style of the illustration based on the estimated emotions.

(Supplementary Note 14) The system according to Supplementary Note 1, wherein the generation unit is configured to generate a plurality of illustrations based on the content of the text data and select the optimal one.

(Supplementary Note 15) The system according to Supplementary Note 1, wherein the generation unit is configured to analyze the context of the text data and generate an illustration including related background information.

(Supplementary Note 16) The system according to Supplementary Note 1, wherein the generation unit is configured to estimate the emotions of meeting participants and adjust the colors of the illustration based on the estimated emotions.

(Supplementary Note 17) The system according to Supplementary Note 1, wherein the generation unit is configured to generate an animation based on the content of the text data and provide dynamic visuals.

(Supplementary Note 18) The system according to Supplementary Note 1, wherein the generation unit is configured to generate a 3D model based on the content of the text data and provide three-dimensional visuals.

(Supplementary Note 19) The system according to Supplementary Note 1, wherein the display unit is configured to estimate the emotions of meeting participants and adjust the display method of the illustration based on the estimated emotions.

(Supplementary Note 20) The system according to Supplementary Note 1, wherein the display unit is configured to adjust the display timing according to the progress of the meeting when displaying the illustration.

(Supplementary Note 21) The system according to Supplementary Note 1, wherein the display unit is configured to customize the display layout according to the theme of the meeting when displaying the illustration.

(Supplementary Note 22) The system according to Supplementary Note 1, wherein the display unit is configured to estimate the emotions of meeting participants and adjust the display size of the illustration based on the estimated emotions.

(Supplementary Note 23) The system according to Supplementary Note 1, wherein the display unit is configured to select the optimal display method in consideration of device information of meeting participants when displaying the illustration.

(Supplementary Note 24) The system according to Supplementary Note 1, wherein the display unit is configured to track the gaze of meeting participants and adjust the display position according to the gaze when displaying the illustration.

What is claimed is:

1. A system comprising:
a communication interface configured to communicate with a client terminal via a packet-switched network;
a memory storing a speech recognition model obtained by machine learning on a neural network and an image generation model obtained by machine learning on a neural network;
circuitry configured to:
receive, from the client terminal via the communication interface, audio data captured by a microphone of the client terminal during a meeting;
extract acoustic features from the audio data, the acoustic features comprising at least one of mel-frequency cepstral coefficients or a spectrogram;
convert the acoustic features into a character string by inputting the acoustic features into the speech recognition model;
extract keywords from the character string and generate a prompt for the image generation model based on the extracted keywords;
generate an illustration by inputting the prompt into the image generation model, the image generation model outputting image data based on the prompt; and
transmit the illustration to the client terminal via the communication interface and the packet-switched network, the illustration causing the client terminal to display the illustration to a user.

2. The system according to claim 1, wherein the circuitry is further configured to convert the acoustic features into the character string in real time by utilizing a streaming speech recognition algorithm of the speech recognition model, the real time comprising a delay of a few seconds or on the order of milliseconds.

3. The system according to claim 1, wherein the speech recognition model comprises at least one of a convolutional neural network or a recurrent neural network, and wherein the acoustic features comprise at least one of a one-dimensional array of audio waveform samples or a two-dimensional spectrogram tensor.

4. The system according to claim 1, wherein extracting keywords from the character string comprises inputting the character string into a natural language processing module comprising a transformer-based large language model to perform context analysis and keyword extraction using at least one of TF-IDF weighting or attention weighting.

5. The system according to claim 1, wherein the image generation model comprises at least one of a diffusion model, a generative adversarial network, or a VQ-VAE, and wherein the image data comprises an RGB image tensor.

6. The system according to claim 1, wherein the circuitry is further configured to display the illustration in real time on the client terminal by performing post-processing on the image data, the post-processing comprising at least one of resolution adjustment, scaling, or color correction, and optimizing the image data for a screen size and a resolution of the client terminal.

7. The system according to claim 1, wherein the circuitry is further configured to estimate an emotion of a meeting participant based on the audio data by inputting the audio data into an emotion estimation model stored in the memory, the emotion estimation model outputting an emotion score as a continuous value, and adjust a parameter of the speech recognition model based on the emotion score, the parameter comprising at least one of a recognition threshold, a decoder beam width, or a noise filter strength.

8. The system according to claim 1, wherein the circuitry is further configured to compute an importance score for each statement in the character string using a natural language processing model, and preferentially convert statements having a higher importance score into text data based on a progress of the meeting, the progress comprising at least one of a meeting start phase, a discussion phase, or a conclusion phase.

9. The system according to claim 1, wherein the circuitry is further configured to identify keywords related to a theme of the meeting from the character string using a natural language processing module, and add an emphasis attribute to the identified keywords when converting the audio data into the character string, the emphasis attribute comprising at least one of a bold attribute, a color attribute, or an underline attribute.

10. The system according to claim 1, wherein the circuitry is further configured to estimate an emotion of a meeting participant based on the audio data, and adjust a timing of the speech recognition model based on the estimated emotion, comprising adjusting at least one of a start timing or an end timing of speech segment detection, or a silent interval threshold between statements.

11. The system according to claim 1, wherein the circuitry is further configured to receive environmental sound data from a microphone array of the client terminal, estimate noise components from the environmental sound data using a noise canceling model comprising at least one of a spectral subtraction method, a neural network, or a Wiener filter, and remove the noise components from the audio data before inputting the acoustic features into the speech recognition model.

12. The system according to claim 1, wherein the circuitry is further configured to analyze an utterance frequency of each meeting participant based on the audio data, and select a speech recognition algorithm for each meeting participant based on the utterance frequency, comprising applying a high-accuracy speech recognition algorithm for a participant having a high utterance frequency and a standard speech recognition algorithm for a participant having a low utterance frequency.

13. The system according to claim 1, wherein the circuitry is further configured to estimate an emotion of a meeting participant based on the audio data, and adjust a style parameter of the image generation model based on the estimated emotion, the style parameter comprising at least one of a color tone, a line thickness, or a texture, wherein a soft color and a curvilinear touch are specified when the estimated emotion indicates relaxation, and a vivid color and a dynamic composition are specified when the estimated emotion indicates excitement.

14. The system according to claim 1, wherein the circuitry is further configured to generate a plurality of illustrations by inputting a plurality of prompts specifying different styles into the image generation model, and select an optimal illustration from the plurality of illustrations based on at least one of participant feedback, a number of clicks, gaze concentration data, or an image clarity score.

15. The system according to claim 1, wherein the circuitry is further configured to analyze a context of the character string using a natural language processing module to extract background information related to the character string, and generate a prompt that includes the background information, the image generation model generating the illustration including the background information.

16. The system according to claim 1, wherein the circuitry is further configured to acquire device information of the client terminal, the device information comprising at least one of a device type, a screen resolution, or an operating system version, and select a display method for the illustration based on the device information, comprising at least one of resizing the illustration for a smartphone, displaying the illustration in high resolution for a tablet, or displaying a plurality of illustrations in parallel for a laptop.

17. The system according to claim 1, wherein the circuitry is further configured to acquire gaze data of a meeting participant from the client terminal, the gaze data comprising at least one of gaze coordinates, a gaze movement speed, or a gaze concentration value, and adjust a display position of the illustration based on the gaze data, comprising moving the illustration to an area where the gaze is concentrated or arranging a plurality of illustrations in a distributed manner when the gaze is dispersed.

18. A system comprising:
a communication interface configured to communicate with a client terminal via a packet-switched network, the communication interface supporting at least one of a 5G, Wi-Fi, or Bluetooth communication standard;
a memory storing a speech recognition model comprising at least one of a convolutional neural network or a recurrent neural network obtained by deep learning on a neural network, an image generation model comprising at least one of a diffusion model, a generative adversarial network, or a VQ-VAE, and an emotion identification model;
a database; and
circuitry comprising at least one of a CPU, a GPU, or a TPU, the circuitry configured to:
receive, from the client terminal via the communication interface, audio data captured by a microphone of the client terminal during a meeting;
extract acoustic features from the audio data, the acoustic features comprising at least one of mel-frequency cepstral coefficients or a spectrogram;
convert the acoustic features into a character string by inputting the acoustic features into the speech recognition model;
estimate an emotion of a meeting participant by inputting the audio data into the emotion identification model, the emotion identification model outputting an emotion label and an emotion score;
extract keywords from the character string using a natural language processing module comprising a transformer-based large language model, and generate a prompt for the image generation model based on the extracted keywords and the emotion score;
generate an illustration by inputting the prompt into the image generation model, the image generation model outputting an RGB image tensor, a style of the illustration being adjusted based on the emotion score; and
transmit the illustration to the client terminal via the communication interface and the packet-switched network, the illustration causing the client terminal to display the illustration to the meeting participant.

19. The system according to claim 18, wherein the circuitry is further configured to adjust a parameter of the speech recognition model based on the emotion score, the parameter comprising at least one of a recognition threshold, a decoder beam width, or a noise filter strength, and adjust a display method of the illustration based on the emotion score, the display method comprising at least one of a display position, a display size, or a display speed.

20. A method performed by a system comprising a communication interface, a memory, and circuitry, the method comprising:
receiving, from a client terminal via the communication interface and a packet-switched network, audio data captured by a microphone of the client terminal during a meeting;
extracting acoustic features from the audio data, the acoustic features comprising at least one of mel-frequency cepstral coefficients or a spectrogram;
converting the acoustic features into a character string by inputting the acoustic features into a speech recognition model stored in the memory;
extracting keywords from the character string and generating a prompt for an image generation model stored in the memory based on the extracted keywords;
generating an illustration by inputting the prompt into the image generation model, the image generation model outputting image data based on the prompt; and
transmitting the illustration to the client terminal via the communication interface and the packet-switched network, the illustration causing the client terminal to display the illustration to a user.
